(19) United States
(12) Patent Application Publication
(10) Pub. No.: US 2025/0130248 A1
(43) Pub. Date: Apr. 24, 2025

(54) THERMAL SWITCH FOR DIAGNOSTIC DETECTION CHIP DEVICES AND ASSOCIATED METHODS OF MANUFACTURE AND USE

(71) Applicant: Cepheid, Sunnyvale, CA (US)

(72) Inventors: Gowtham Subramaniam, Sunnyvale, CA (US); Douglas B. Dority, Sunnyvale, CA (US); Matthew Piccini, Sunnyvale, CA (US); Jing Zhang, Sunnyvale, CA (US)

(73) Assignee: Cepheid, Sunnyvale, CA (US)

(21) Appl. No.: 18/920,388

(22) Filed: Oct. 18, 2024

Related U.S. Application Data
(60) Provisional application No. 63/592,087, filed on Oct. 20, 2023.

(51) Int. Cl. G01N 35/00; G01K 13/12

(52) U.S. Cl. CPC G01N 35/00594; G01K 13/12; G01N 2035/00386; G01N 2035/00425

(57) ABSTRACT

Thermal control devices utilizing a thermal switch to facilitate cooling of a biological sample, particularly a biological sample tested with a semiconductor diagnostic detection chip. Such thermal switches can include a mass of thermally conductive material, such as copper or aluminum, that selectively contacts the diagnostic chip or sample tube by use of an air cylinder or a servo-driven moveable support. Alternatively, the thermal switch can utilize a thermally conductive material that selectively contacts the diagnostic chip or sample tube by use of an inflatable bladder. Alternatively, the thermal switch can utilize a voice coil and a heat sink to selectively contact the diagnostic chip. The thermal control device can further include thermal overshoot feature, such as an air blower or placement of a heat sink in close proximity to the chip or tube. Associated methods of assembly and use of thermal control devices are also provided herein.

### CROSS-REFERENCE TO RELATED APPLICATION

This application claims the benefit of and priority to U.S. Application No. 63/592,087, filed on Oct. 20, 2023, the disclosure of which is hereby incorporated by reference in its entirety.

This application is generally related to U.S. application Ser. No. 16/577,650 entitled “System, Device and Methods of Sample Processing Using Semiconductor Detection Chips” filed on Sep. 20, 2019; U.S. application Ser. No. 15/718,840 entitled “Fluidic Bridge Device and Sample Processing Methods” filed Sep. 28, 2017; U.S. Pat. No. 6,374,684 entitled “Fluid Control and Processing System,” filed Aug. 25, 2000; U.S. Pat. No. 8,048,386 entitled “Fluid Processing and Control,” filed Feb. 25, 2002; and U.S. application Ser. No. 15/217,902 entitled “Thermal Control Device and Methods of Use” filed Jul. 22, 2016; each of which is incorporated herein by reference in its entirety for all purposes.

### BACKGROUND

The present disclosure relates generally to temperature control devices for thermal cycling of samples in diagnostic detection chip devices, as well as methods of manufacture, assembly and use, in particular, thermal switches for rapid cooling.

In recent years, there has been considerable development in the use of semiconductor detection chips in performing fluid sample analysis (e.g. testing of clinical, biological, or environmental samples). One continual challenge in conventional MEMs technologies in diagnostics has been the lack of flexible sample preparation front end to provide a fluid sample suitable for analysis with the semiconductor chips. Sample preparation of such fluid samples involves a series of processing steps, including thermal cycling for sample preparation before performing detection of the prepared fluid sample with a diagnostic chip. Whether incorporated into a bench-top instrument, a portable analyzer, a disposable cartridge, or a combination thereof, such processing typically involves complex assemblies and processing algorithms. Thermal cycling, in particular, is often one of the more time consuming processes in sample preparation.

Conventional approaches for processing fluid samples typically involves substantial manual operation, while more recent approaches have sought to automate many of the processing steps and can include the use of sample cartridges that employ a series of regions or chambers each configured for subjecting the fluid sample to a specific processing step. As the fluid sample flows through the cartridge sequentially from region or chamber to a subsequent region or chamber of the cartridge, the fluid sample undergoes the processing steps according to a specific protocol. Such systems, however, generally include an integrated means of analysis, and are not typically amenable to use with a semiconductor chip. The standard approach of utilizing semiconductor detection chips, such as “lab on a chip” devices, generally requires a considerably complex, time-consuming and costly endeavor, requiring the chip be incorporated into a conventional chip package and then incorporated into much larger systems utilizing conventional fluidic transport means to transport a fluid sample to the chip device. The fluid sample is typically prepared by one or more entirely separate systems (often including manual interaction) and then pipetted into the fluid transport system to be supplied to the chip package. These challenges associated with pre and post testing processes often minimize the advantages and benefits of such “lab on a chip” devices and present a practical barrier to their widespread use and acceptance in diagnostic testing. In order to make high functionality MEMS/silicon chip technologies feasible in the context of high volume diagnostic testing, it has been proposed to incorporate such devices with existing sample cartridge technologies that perform sample preparation. While this approach represents a marked advancement in the art, the conventional means of thermal cycling are less suited for use with semiconductor chips for various reasons.

Thus, there is need for systems and methods that improves efficiency of thermal cycling of fluid samples when used with a semiconductor diagnostic chips, particularly chips incorporated within sample preparation systems, such as an assay cartridge and module that performs sample preparation. There is further need for developing such thermal cycling components and methods that are compatible with existing sample processing technologies to allow for seamless integration of the diagnostic chip with existing sample preparation technologies. There is further need to perform more rapid thermal cycling for PCR testing by use of conductive heat transfer that is not susceptible to dust and that is less susceptible to ambient temperature. PCR thermal cycling requires precise temperature control for accurate results.

### SUMMARY

In general terms, this disclosure is directed to Thermal Switch for Diagnostic Detection Chip Devices and Associated Methods of Manufacture and Use. In some embodiments, and by non-limiting example, the present disclosure provides thermal control components that can be utilized for thermal cycling of samples analyzed by diagnostic detection chips and chip devices (also referred to as “chip,” “detection chip,” “semiconductor chip,” and “diagnostic chip”). Various approaches are provided that lower the costs of semiconductor detection chips and chip devices by improving integration of the semiconductor chip itself within the overall device.

In a first aspect, the disclosure pertains to a thermal control unit that facilitates cooling by thermal conduction utilizing a slug of thermally conductive metal. In some embodiments, the unit includes the slug, which is also referred to as a mass, a cradle supporting the mass of thermally conductive material so as to be movable within the cradle, the cradle having a distal portion that is engaged adjacent a semiconductor diagnostic chip and/or a chip carrier device supporting the diagnostic chip; and an air cylinder coupled to the cradle and having an air passage by which pressurized air is transmitted to move the slug in a distal direction so that the slug moves within the cradle and contacts a surface of the diagnostic chip to cool the diagnostic chip by thermal conduction. In some embodiments, the slug is a mass of a metal having a protruding portion that is shaped and dimensioned to contact the surface of the diagnostic chip. The thermally conductive material can be a metal, such as copper, or any suitable material. In some embodiments, the thermal control unit further includes: a control unit configured to selectively apply pressurized air via the air cylinder so as to selectively move and engage the diagnostic chip with the slug during one or more cooling portions of thermal cycling. In some embodiments, the thermal control unit further includes: a heater positioned adjacent the diagnostic chip and configured to selectively heat the diagnostic chip during heating portions of thermal cycling.

In another aspect, the invention pertains to a thermal control unit that facilitates cooling by use of a flexible thermally conductive material and inflatable bladder. In some embodiments, the thermal control unit includes: a chip carrier device having one or more layers for supporting a semiconductor chip therein; a thermally conductive layer disposed adjacent the diagnostic chip and movable between a first position spaced apart from the diagnostic chip and second position in contact with the diagnostic chip; and an inflatable bladder disposed adjacent the diagnostic chip with the thermally conductive layer disposed between the inflatable bladder and the diagnostic chip. In some embodiments, the bladder itself is formed of the thermally conductive material. The assembly can be configured such that when the inflatable bladder is inflated, the thermally conductive material in the second position contacts a backside of the diagnostic chip and when the inflatable bladder is deflated the thermally conductive material is disposed in the first position spaced apart from the backside of the diagnostic chip. The control unit can further include an air pump coupled with the inflatable bladder. In some embodiments, the air pump is provided on-board the chip carrier device. In other embodiments, the air pump is disposed in an instrument of a module that interfaces with the chip carrier device and removably couples with the inflatable bladder through one or more conduits or openings through one or more layers of the chip carrier device. The thermally conductive material comprises a PGS film or layer. In some embodiments, the control unit operatively coupled with the air pump and configured to selectively inflate the inflatable bladder to effect cooling during cooling portions of thermal cycling. In some embodiments, the control unit is further configured to deflate the inflatable bladder after cooling during the thermal cycling process to facilitate heating during heating portions of thermal cycling. In some embodiments, the thermal control unit further includes a heater disposed adjacent the diagnostic chip to effect heating during the thermal cycling process. The controller can further be configured to selectively heat the heater to facilitate heating and selectively inflate the inflatable bladder for cooling so as to cycle between heating and cooling during thermal cycling of a biological sample in contact with the diagnostic chip. The heater can be a thermoelectric cooler, a resistive heater, or any suitable heating element. In some embodiments, the heater is thermally coupled with the thermally conductive material to distribute heat across the backside of the diagnostic chip.

In another aspect, the disclosure pertains to a thermal control unit that facilitates cooling by a moveable heat sink. In some embodiments, the thermal control unit includes: a heat sink including a mass of thermally conductive material, where the heat sink includes: a protruding portion that is sized and dimensioned to engage a surface of a diagnostic chip; a moveable support that supports the heat sink and is configured to move the heat sink between multiple positions; and a controller configured to move the moveable support between the multiple positions, including a first position spaced away from the diagnostic chip to facilitate heating and a second position where the protruding portion is in contact with the surface of the diagnostic chip to facilitate cooling. The thermally conductive material can be a metal, such as aluminum. In some embodiments, the thermally conductive material includes any of: aluminum, black anodized aluminum, or a combination thereof.

In another aspect, the thermal control unit can include one or more features to inhibit thermal overshoot. Thermal overshoot is the temperature bounce back after the thermally conductive material loses contact with the diagnostic chip once it reaches target temperature on cooling. In some embodiments, the one or more features to inhibit thermal overshoot can include an air blower that directs air at the surface of the diagnostic chip after cooling to inhibit thermal overshoot after the heat sink is withdrawn from the surface of the diagnostic chip. In some embodiments, the air blower includes a fan that directs air through an air outlet disposed in the protruding portion of the heat sink directly at the surface of the diagnostic chip. In some embodiments, the one or more features to inhibit thermal overshoot include maintaining a heat sink in close proximity to the surface of the diagnostic chip after cooling to suppress thermal overshoot. In some embodiments, the close proximity is 3 mm or less from the surface of the diagnostic chip. In some embodiments, the close proximity a distance between 0 and 0.5 mm from the surface of the diagnostic chip. In some embodiments, the control unit determines the number of “proximity positions” to suppress the overshoot, depending on the overshoot magnitude. The “proximity positions” have varying level of cooling rate, position closer to the chip has higher level of cooling capacity and it reduces as the thermal conductive material move away from the diagnostic chip. The control unit uses these “proximity positions” to its advantage to cool the diagnostic chip and also to suppress the overshoot.

In some embodiments, the thermal control unit is disposed entirely on an instrument of a module that interfaces with a chip carrier device supporting the diagnostic chip that is attached to a sample cartridge inserted into the module. In some embodiments, particularly related to the inflatable bladder configuration, differing pressures may be used for inflation to ensue proportional heating and or cooling. The different pressures would allow proportional bladder deflection thereby allowing for proportional contact area between the chip and bladder propelled flexible conductive material. This would allow for throttling of cooling rates and even heating rates and help mitigate overshoot. In addition once full contact area is achieved continued thermal proportionality may continue by varying the force that the full contact area exerts on the chip in this regime, the thermal contact resistance is varied.

Another aspect is a method of cooling a diagnostic chip, the method comprising the steps of: (a) contacting a surface of the diagnostic chip with a heat sink comprising a mass of thermally conductive material, wherein the heat sink comprises a protruding portion that is sized and dimensioned to engage the surface of the diagnostic chip; (b) ending the contact between the surface of the diagnostic chip and the heat sink; and (c) repeating steps (a) and (b) at least once more. In some embodiments, step (a) lasts for at least 10 milliseconds. In some embodiments, step (b) lasts for at least 10 milliseconds.

Yet another aspect is a method for cooling a diagnostic chip, the method comprising the steps of: (a) vibrating a heat sink comprising a mass of thermally conductive material, wherein the heat sink comprises a protruding portion that is sized and dimensioned to engage a surface of the diagnostic chip, within a thermal boundary of the diagnostic chip; (b) increasing the distance between the diagnostic chip and the heat sink such that the heat sink is not vibrating within the thermal boundary of the diagnostic chip, and (c) repeating steps (a) and (b) at least once more. In some embodiments, step (a) lasts for at least 10 milliseconds. In some embodiments, step (b) lasts for at least 10 milliseconds. In some embodiments, during step (b) the vibration of the heat sink cools itself from the thermally conductive material cooling the diagnostic chip in step (a). In some embodiments, during step (a) the cooling rate of the diagnostic chip is inversely proportional to the distance between the heat sink and the surface of the diagnostic chip.

Another aspect is a method of cooling a diagnostic chip, the method comprising the steps of: (a) contacting a surface of the diagnostic chip with a heat sink comprising a mass of thermally conductive material, wherein the heat sink comprises a protruding portion that is sized and dimensioned to engage the surface of the diagnostic chip; (b) ending the contact between the surface of the diagnostic chip and the heat sink; and (c) repeating steps (a) and (b) at least once more. In some embodiments, the method is followed by a method comprising the steps of: (a) vibrating a heat sink comprising a mass of thermally conductive material, wherein the heat sink comprises a protruding portion that is sized and dimensioned to engage a surface of the diagnostic chip, within a thermal boundary of the diagnostic chip; (b) increasing the distance between the diagnostic chip and the heat sink such that the heat sink is not vibrating within the thermal boundary of the diagnostic chip, and (c) repeating steps (a) and (b) at least once more.

Yet another aspect is a method for performing a thermal control operation on a diagnostic chip, the method comprising: moving a heat sink toward a surface of the diagnostic chip; maintaining the heat sink within a thermal boundary of the diagnostic chip; moving the heat sink away from the surface of the diagnostic chip; maintaining the heat sink outside of the thermal boundary of the diagnostic chip; and repeating moving a heat sink toward a surface of the diagnostic chip, maintaining the heat sink within a thermal boundary of the diagnostic chip, moving the heat sink away from the surface of the diagnostic chip, and maintaining the heat sink outside of the thermal boundary of the diagnostic chip at least once more; and wherein the heat sink comprises a mass of thermally conductive material and a protruding portion that is sized and dimensioned to engage the surface of the diagnostic chip, and wherein when the heat sink is within the thermal boundary of the diagnostic chip it cools the diagnostic chip. In some embodiments, moving the heat sink away from the surface of the diagnostic chip results in moving the heatsink outside of the thermal boundary of the diagnostic chip. In some embodiments, a controller controls the movement of the heat sink to control a diagnostic chip temperature to a predetermined temperature or temperature range. In some embodiments, the duty cycle may be within the range of 0 to 100%. In some embodiments, moving a heat sink toward a surface of the diagnostic chip and maintaining the heat sink within a thermal boundary of the diagnostic chip lasts for a total of at least 10 milliseconds. In some embodiments, moving the heat sink away from the surface of the diagnostic chip and maintaining the heat sink outside of the thermal boundary of the diagnostic chip lasts for a total of at least 10 milliseconds.

### BRIEF DESCRIPTION OF THE DRAWINGS

FIG. 1 is an overview of a sample cartridge fluidically coupled with a chip carrier device supporting a semiconductor diagnostic chip and an associated instrument interface of a module having an electrical interface connector for operating the diagnostic chip and a thermal component for thermal cycling, in accordance with some embodiments of the invention.

FIG. 2A illustrates the instrument interface board of the module, the instrument interface board having an array of electrical contacts for interfacing with electrical contact pads of the chip device, in accordance with some embodiments.

FIG. 2B illustrates an inserted chip device secured within the chip carrier device and an example electrical coupling and a thermal component for thermal cycling, in accordance with some embodiments.

FIG. 3 illustrates a detailed view of the sample cartridge fluidically coupled with a chip carrier device, in accordance with some embodiments.

FIG. 4A illustrates a step in a method of fabricating and assembling diagnostic chip devices, in accordance with some embodiments.

FIG. 4B illustrates a step in a method of fabricating and assembling diagnostic chip devices, in accordance with some embodiments.

FIG. 4C illustrates a step in a method of fabricating and assembling diagnostic chip devices, in accordance with some embodiments.

FIG. 4D illustrates a step in a method of fabricating and assembling diagnostic chip devices, in accordance with some embodiments.

FIG. 4E illustrates a step in a method of fabricating and assembling diagnostic chip devices, in accordance with some embodiments.

FIG. 5A illustrates an assembly of a chip device assembly, in accordance with some embodiments.

FIG. 5B illustrates an assembly of a chip device assembly, in accordance with some embodiments.

FIG. 5C illustrates an assembly of a chip device assembly, in accordance with some embodiments.

FIG. 5D illustrates an assembly of a chip device assembly, in accordance with some embodiments.

FIG. 6A illustrates a method of fabricating, assembling diagnostic chip devices, in accordance with some embodiments.

FIG. 6B illustrates a method of fabricating, assembling diagnostic chip devices, in accordance with some embodiments.

FIG. 6C illustrate a method of fabricating, assembling diagnostic chip devices, in accordance with some embodiments.

FIG. 7A illustrates a method of fabricating, assembling diagnostic chip devices, in accordance with some embodiments.

FIG. 7B illustrates a method of fabricating, assembling diagnostic chip devices, in accordance with some embodiments.

FIG. 7C illustrates a method of fabricating, assembling diagnostic chip devices, in accordance with some embodiments.

FIG. 8 illustrates a diagnostic chip device before an instrument interface, in accordance with some embodiments.

FIG. 9A illustrates an integrated diagnostic chip and chip device, in accordance with some embodiments.

FIG. 9B illustrates an integrated diagnostic chip and chip device, in accordance with some embodiments.

FIG. 9C illustrates an integrated diagnostic chip and chip device, in accordance with some embodiments.

FIG. 10A shows an idealized thermal profile controlled to thermally cycle between elevated and reduced temperatures by a square wave, in accordance with some embodiments.

FIG. 10B shows a thermal profile of a semiconductor diagnostic chip, without any thermal component applied, demonstrating gradual cooling from the elevated temperature to the reduced temperature.

FIG. 11 shows a chip and interface assembly that includes a thermal control component with thermal switch defined by a copper slug, in accordance with some embodiments.

FIG. 12 shows a comparison of the conventional thermal profile of the semiconductor diagnostic chip as compared to an improved thermal profile provided by use of the thermal switch of FIG. 11, in accordance with some embodiments.

FIG. 13 shows another thermal control component including a thermal switch that uses an inflatable bladder, in accordance with some embodiments.

FIG. 14 shows a side view of the thermal control component using an inflatable bladder thermal switch, in accordance with some embodiments.

FIG. 15A shows a cross-sectional view of the thermal control component using an inflatable bladder thermal switch, in accordance with some embodiments.

FIG. 15B shows a detail view of the thermal control component using an inflatable bladder thermal switch, in accordance with some embodiments.

FIG. 16A shows a side view of a variable inflation inflatable bladder that provides variable thermal resistance, in accordance with some embodiments.

FIG. 16B shows a side view of a variable inflation inflatable bladder that provides variable thermal resistance, in accordance with some embodiments.

FIG. 16C shows a side view of a variable inflation inflatable bladder that provides variable thermal resistance, in accordance with some embodiments.

FIG. 16D shows a side view of a variable inflation inflatable bladder that provides variable thermal resistance, in accordance with some embodiments.

FIG. 17 shows a thermal profile of the semiconductor diagnostic chip utilizing an inflatable bladder thermal switch, in accordance with some embodiments.

FIG. 18A shows a front view of a chip carrier device with semiconductor diagnostic chip therein, in accordance with some embodiments.

FIG. 18B shows a back view of a chip carrier device with semiconductor diagnostic chip therein, in accordance with some embodiments.

FIG. 18C shows an isometric view of a chip carrier device with semiconductor diagnostic chip therein, in accordance with some embodiments.

FIG. 19A shows application of a thermal switch defined by a movable heat sink during heating, in accordance with some embodiments.

FIG. 19B shows application of a thermal switch defined by a movable heat sink during cooling, in accordance with some embodiments.

FIG. 20A shows views of a thermal control unit during heating having thermal overshoot features in accordance with some embodiments.

FIG. 20B shows views of a thermal control unit during cooling having thermal overshoot features, in accordance with some embodiments.

FIG. 21 shows a thermal profile of cooling using the thermal control component of FIG. 20A, in accordance with some embodiments.

FIG. 22 shows a chip and interface assembly that includes a thermal control component with thermal switch defined by a heat sink operating in conjunction with a voice coil, in accordance with some embodiments.

FIG. 23 shows a thermal profile of cooling of a chip using the thermal control component of FIG. 22 and a cooling method of multiple steps, in accordance with some embodiments.

FIG. 24 shows the thermal profile of cooling of a silicon chip for multiple runs using the thermal control component of FIG. 22 and a cooling method of multiple steps of FIG. 23, in accordance with some embodiments.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates generally to a system, devices and methods for controlling temperature for thermal cycling of a diagnostic chip, particularly when disposed in a chip carrier device attached to a sample cartridge within a diagnostic module.

### I. Overview

In one aspect, the invention pertains to a thermal component that includes a thermal switch to improve cooling of a semiconductor diagnostic chip during cooling, thereby improving efficiency of thermal cycling. In some embodiments, the thermal component is designed to interface the thermal switch by engaging the diagnostic chip while disposed within a chip carrier device. The chip carrier device includes one or more fluid conduits that are fluidly coupleable with one or more ports of a sample cartridge to facilitate transport of a processed fluid sample from the cartridge into the chip carrier device through the one or more fluid conduits to facilitate transport of the fluid sample to the semiconductor chip in the chip carrier device. The sample cartridge is received by a module which facilitates operation of the sample cartridge to perform processing and transport of the processed fluid sample into the chip carrier device and includes an instrument interface that electrically connects to the chip carrier device to facilitate operation of the semiconductor chip carried within the chip carrier device and operate the thermal components to perform thermal cycling.

### A. Chip

As described herein, the term “chip” can refer to the chip itself or a chip device that includes the chip and an underlying support substrate and adjacent electrical interface that is electrically connected to the chip. Typically, the chip includes a silicon sensor element having an active face that is sealingly engaged with a flowcell filled with a prepared fluid sample. In some embodiments, the chip device is designed and configured to be carried within a chip carrier device having an integrated flowcell and fluid control features so as to be compatible for use with a sample processing module as described above. The chip device can be bonded within the recess of the chip carrier device or can be pressed into the recess and secured by a friction fit. The chip is provided to the user already secured within a chip carrier device, or an end user can assemble the chip within a chip carrier device.

In some embodiments, the semiconductor diagnostic chip is configured to perform sequencing of a nucleic acid target molecule by nanopore sequencing, which detects changes in electrical conductivity and does not require optical excitation or detection. The underlying technologies of such chips can be further understood by referring to U.S. Pat. No. 8,986,928. In some embodiments, the semiconductor diagnostic chip analyzes other attributes of a target molecule in the sample, such as molecular weight and similar characteristics. Such technologies can be further understood by referring to: Xiaoyun Ding, et al. Surface acoustic wave microfluidics. Lab Chip. 2013 Sep. 21; 13 (18): 3626-3649. In some embodiments, the semiconductor diagnostic chip uses surface plasmon resonance to provide analysis of a target molecule, for example as used in the Biocore™ systems provided by GE Healthcare UK Limited and as described in their Biocore Sensor System Handbook (see gelifesciences.com/biacore). The entire contents of each of the above references are incorporated herein by reference in their entirety.

Typically, the chip is a semiconductor diagnostic detection chip, including but not limited to CMOS, ISFET, bulk acoustic, non-bulk acoustic chips, piezo-acoustic, and pore array sensor chips. While semiconductor diagnostic chips are preferred, it is appreciated that the concepts described herein are applicable to any type of chip suitable for use in performing processing or analysis of a fluid sample.

### B. Chip Carrier Device

The chip carrier device is adapted to fluidically couple a semiconductor chip to a sample cartridge as described herein. In some embodiments, the chip carrier device includes an electrical interface adapted to interface with an instrument interface board of a sample processing module which operates the sample processing cartridge. It is appreciated that the chip carrier device can be configured for use with any type of chip. In some embodiments, the chip carrier device is designed to allow analysis of the biological fluid sample with the chip by electrical operation of the chip by the instrument interface of the module. This is accomplished through electrical probe contact pads of the chip device that are electrically connected to the instrument interface of the module.

A configuration as described above allows for a more seamless transition between processing of the fluid sample with the sample cartridge and subsequent processing or analysis of the fluid sample with the chip in the chip carrier device. This configuration facilitates industry development of semiconductor chip devices by standardizing processing or preparation of the sample and delivery of the processed sample to the chip device. Preparation of the sample can be a time consuming and laborious process to perform by hand and can be challenging to develop within a next generation chip device. By utilizing a chip carrier device instead of the reaction tube, the user can utilize the sample cartridge to prepare the sample in a sample cartridge and subsequently transport the prepared sample into the attached chip carrier device for analysis with the semiconductor chip device carried therein. Such a configuration expedites development of semiconductor chip by utilizing existing sample preparation processes, originally configured for PCR detection, and allowing use of such processes with a chip device.

In some embodiments, the chip carrier device can include one or more processing features in fluid communication with one or more of the fluid flow channels, such as one or more chambers, filters, traps, membranes, ports and windows, to allow additional processing steps during transport of the fluid sample to the second sample processing device. Such chambers can be configured for use with an amplification chamber to perform nucleic acid amplification, filtration, chromatography, hybridization, incubation, chemical treatment, e.g., bisulfite treatment and the like. In some embodiments, the chamber allows for accumulation of a substantial portion of the fluid sample, if not the entire fluid sample, for further processing or analysis as needed for a particular protocol.

### C. Sample Cartridge

The sample cartridge can be any device configured to perform one or more process steps relating to preparation and/or analysis of a biological fluid sample according to any of the methods described herein. In some embodiments, the sample cartridge is configured to perform at least sample preparation. The sample cartridge can further be configured to perform additional processes, such as detection of a target nucleic acid in a nucleic acid amplification test (NAAT), e.g., Polymerase Chain Reaction (PCR) assay, by use of a reaction tube attached to the sample cartridge. Preparation of a fluid sample generally involves a series of processing steps, which can include chemical, electrical, mechanical, thermal, optical or acoustical processing steps according to a specific protocol. Such steps can be used to perform various sample preparation functions, such as cell capture, cell lysis, binding of analyte, and binding of unwanted material.

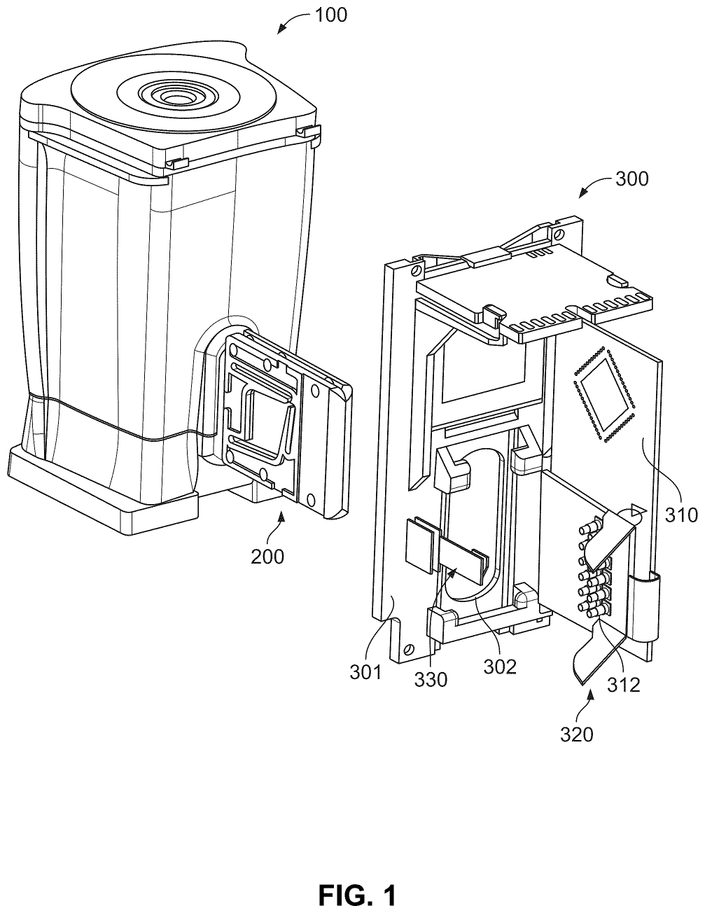

A sample cartridge suitable for use with the invention, includes one or more transfer ports through which the prepared fluid sample can be transported into a reaction tube for analysis. FIG. 1 illustrates an exemplary sample cartridge 100 suitable for use with a chip carrier device 200 in accordance with some embodiments. Conventionally, such a sample cartridge is associated with a planar reaction tube adapted for analysis of a fluid sample processed within the sample cartridge 100. Such a sample cartridge 100 includes various components including a main housing having one or more chambers for processing of the fluid sample, which typically include sample preparation before analysis. In accordance with its conventional use, after the sample cartridge 100 and reaction tube are assembled and a biological fluid sample is deposited within a chamber of the sample cartridge, the cartridge is inserted into a cartridge processing module configured for sample preparation and analysis. The cartridge processing module then facilitates the processing steps needed to perform sample preparation and the prepared sample is transported through one of a pair of transfer ports into the fluid conduit of the reaction tube attached to the housing of the sample cartridge 100. The prepared biological fluid sample is then transported into a chamber of the reaction tube through a fluidic interface of the reaction tube where the biological fluid sample undergo nucleic acid amplification and testing to indicate the presence or absence of a target nucleic acid analyte of interest, e.g., a bacteria, a virus, a pathogen, a toxin, or other target analyte, for example by use of an excitation and optical detection means. Such a sample cartridge can also be utilized to perform analysis with the semiconductor chips described herein by use of a chip carrier device, which is fluidically coupleable to the sample cartridge in the same or similar manner as a conventional reaction tube.

An exemplary use of a sample cartridge with a planar reaction tube configured for controlled fluid control of a prepared fluid sample is described in commonly assigned U.S. Pat. No. 6,818,185, entitled “Cartridge for Conducting a Chemical Reaction,” filed May 30, 2000, the entire contents of which are incorporated herein by reference for all purposes. Examples of the sample cartridge and associated module are also shown and described in U.S. Pat. No. 6,374,684, entitled “Fluid Control and Processing System” filed Aug. 25, 2000, and U.S. Pat. No. 8,048,386, entitled “Fluid Processing and Control,” filed Feb. 25, 2002, the entire contents of which are incorporated herein by reference in their entirety for all purposes.

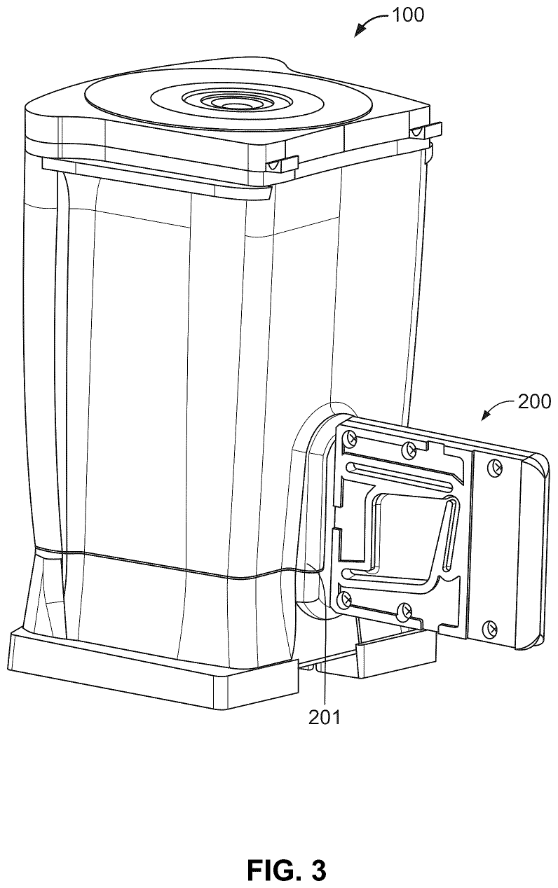

Various aspects of the sample cartridge 100 shown in FIG. 3 can be further understood by referring to U.S. Pat. No. 6,374,684, which described certain aspects of the sample cartridge in greater detail. Such sample cartridges can include a fluid control mechanism, such as a rotary fluid control valve, that is connected to the chambers of the sample cartridge. Rotation of the rotary fluid control valve permits fluidic communication between chambers and the valve so as to control flow of a biological fluid sample deposited in the cartridge into different chambers in which various reagents can be provided according to a particular protocol as needed to prepare the biological fluid sample for analysis. To operate the rotary valve, the cartridge processing module comprises a motor such as a stepper motor that is typically coupled to a drive train that engages with a feature of the valve in the sample cartridge to control movement of the valve and resulting movement of the fluid sample according to the desired sample preparation protocol. Fluid metering and distribution functions of the rotary valve can be utilized and controlled to perform a particular sample preparation protocol.

It is appreciated that the sample cartridge described above is but one example of a sample processing device suitable for use with the chip carrier devices in accordance with embodiments described herein. While chip carrier configurations that allow for use of such a sample cartridge are particularly advantageous as they allow utilization of existing sample cartridges and sample processing devices, it is appreciated that the concepts described herein in regard to the chip design can be applied to other sample processing devices, for example, the dual piston rotary valve device described in U.S. Pat. No. 7,032,605, incorporated herein by reference. It is further appreciated that the chip designs described herein can be configured to be compatible with various other chip carrier devices, sample cartridge configurations or other fluid sample processing devices and components, for example, any of those described in U.S. Provisional Application No. 62/734,079 filed Sep. 20, 2018, incorporated herein by reference.

### D. Instrument Interface

In another aspect, the module includes an instrument interface to facilitate powering and communication with the chip and operation of the thermal component for thermal cycling. The instrument interface can include a circuit board adapted to engage an electrical interface of the chip device to allow the module to electrically power, control and communicate with the chip device. In some embodiments, the instrument interface is located within a common housing of the module to provide more seamless processing between the sample cartridge and the chip device. The instrument interface can be controlled by the module in coordination with transport of the fluid sample from the sample cartridge to the chip.

In some embodiments, the instrument interface board includes an electrical connector with pogo contacts and is mechanically mounted on a pivot that moves toward the chip carrier device when received within the module. The instrument interface board is configured to pivot from an open position before the sample cartridge is loaded to an engaged position when loaded. A cam (not shown) positions the interface board so that the probes contact the electrical interface of the chip device. The probe contacts are typically pogo pins on the instrument interface board that contact corresponding probe contact pads on the electrical interface of the chip device to allow the module to control analysis of the fluid sample with the chip. The instrument interface board can also host passive and active electronic components in addition to those of the chip carrier as needed for various other tasks. For example, such components could include any components needed for signal integrity, amplification, multiplexing or other such tasks.

The instrument interface board can also include the thermal component that engages the diagnostic chip within the chip carrier and/or can include components that facilitate operations of the thermal component carried on-board the chip carrier device. The components can include air pumps/blowers, servo motors, or any suitable means to facilitate operation of the thermal component as described herein.

### E. Example Systems

FIG. 1 illustrates an overview of a system utilizing a conventional sample cartridge 100 fluidically coupled with a chip carrier device 200. The sample cartridge 100 is adapted for insertion into a bay of a sample processing module configured to perform one or more processing steps on a fluid sample contained within the sample cartridge through manipulation of the sample cartridge. An instrument interface 300 of the module is incorporated into the module within the bay in which sample cartridge 100 is received and includes a plate 301 having a receptacle opening 302 through which the chip carrier device 200 extends when cartridge 100 is positioned within the bay. The instrument interface 300 further includes an instrument board 310, such as a PCB board, that extends alongside a major planar surface of chip carrier device 200 and includes electrical contacts 312 arranged so as to electrically couple with corresponding probe contact pads on the major planar surface of the chip device. The instrument interface includes an electrical connector 320 that includes the pogo contacts 312 and frame and cam (not shown) to control pivoting movement of the pogo contacts to engage with corresponding contacts on the chip. The instrument interface further includes a thermal component 330 to facilitate thermal cycling of the sample on the diagnostic chip. In this embodiment, the thermal component 330 includes a heat sink that is moved to contact the chip during cooling.

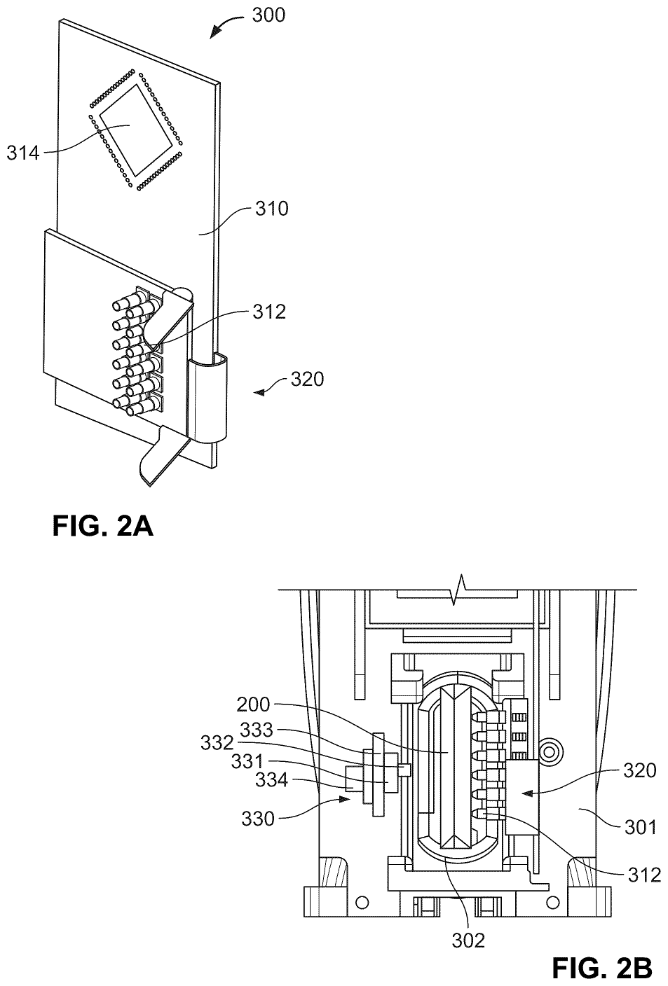

FIG. 2A illustrates the instrument interface board 310 of the module with a mounting 314 for a processor, such as a microprocessor, and the electrical connector 320 with pogo contacts 312 for interfacing with electrical contact pads of the chip device. Typically, the contacts 312 are arranged in a pattern, such as a rectangular array, that corresponds to the contacts of the chip device. In this embodiment, the contacts 312 are configured as pogo-pins so as to deflect upon insertion of the chip carrier device 200 through receptacle opening 302 to provide secure electrical coupling between pogo contacts 312 of pogo connector 320 and corresponding probe contact pads on the instrument interface of the chip device secured within the chip carrier device 200, as shown in FIG. 2B. Although a rectangular array of pogo-pins is depicted here, it is appreciated that the electrical contacts could be arranged in various other patterns, in accordance with a corresponding chip carrier device and that various other contact constructions could be realized. In some embodiments, the electrical contacts could be configured as one or more edge connectors or other types of multi-pin connector arrangements. It is further appreciated that the instrument interface need not utilize every contact so as to be compatible for use with a chip carrier device having differing numbers or arrangements of contact pads, as desired. In some embodiments, the electrical contacts could include an additional adapter so as to be suitable for use with various differing types of chip carrier devices. In some embodiments, it may be cost effective to package a semiconductor controller as an adjunct to the chip carrier device such that the signal connectivity is minimized. Such an approach could use any suitable connector means, which can include a standard connector type, such as a USB interface (e.g. [+1, −2, sig 3, sig 4]). The thermal component 330 includes a heat sink 331 having a protruding portion 332 that is sized and dimensioned to contact an exposed surface of the chip when the chip carrier is inserted into the module. The heat sink is mounted on a moveable support 333 and movement of the heat sink toward the chip is controlled by a servo motor 334.

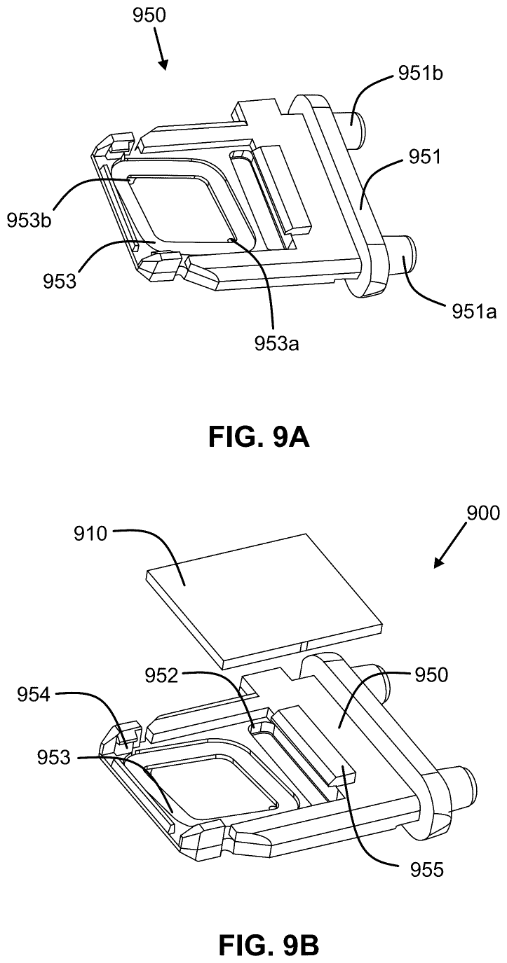

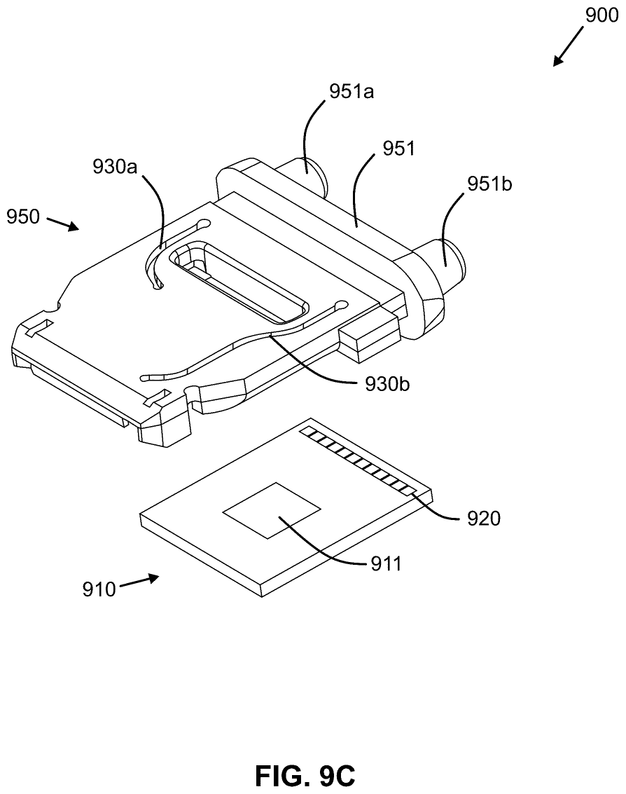

FIG. 3 illustrates a detailed view of the sample cartridge 100 fluidically coupled with chip carrier device 200 with integrated fluid flow control, in accordance with some embodiments. Typically, the chip carrier device 200 is a planar device that includes a flowcell chamber for engaging against the active area of the chip and a fluidic interface 201 that fluidically couples to a fluid sample container, such as sample cartridge 100. In this embodiment, the fluidic interface 201 fluidically couples to the sample cartridge 100 and includes a pair of fluid ports (not visible) that couple with corresponding fluid ports of the sample cartridge. On one side of the planar device is the flowcell chamber, for example, as shown in FIG. 9A. The other side of the planar device can include one or more fluid control features, such as an amplification chamber. The chip carrier device can be formed from a suitably rigid material such that the chip carrier device 200 extends outward from the sample cartridge 100, which allows clearance for various other components, such as the instrument interface board of the module and/or thermal cycling units.

The chip carrier device 200 includes a fluidic interface 201 that can be configured with fluid ports (e.g. Luer type ports) and flange arrangement that is the same or similar as that of a typical PCR reaction tube so that the fluid sample adapter can easily interface with existing sample cartridges, as described previously. It is appreciated however that various other types of fluid ports (e.g. Luer type ports, pressure fit, friction fit, snap-fit, click-fit, screw-type connectors, etc.) in various other arrangements could be used. Typically, the fluidic pathways are defined in a first substrate and sealed by a second substrate, such as a thin film, similar to the construction of conventional PCR reaction tubes. In some embodiments, the fluid sample adapter also features alignment and assembly bosses as well as mechanical snaps so that a chip carrier component or chip can be secured against a flowcell of the flowcell portion with ease. In some embodiments, the chip carrier device includes one or more channels that extend between fluid-tight couplings without any chambers, valves or ports between the proximal and distal ends. In other embodiments, the device includes one or more valves, or ports. In some embodiments, the one or more channels can include one or more chambers or regions, which can be used to process or analyze the fluidic sample, for example, chambers or regions for thermal amplification of a nucleic acid target, filtration of the sample, chromatographic separation of the sample, hybridization, and/or incubation of the sample with one or more assay reagents.

As can be seen in the example of FIG. 9A, the fluidic path leads to a flowcell chamber 953 through set of flowcell ports 953a, 953b within the flowcell. In this embodiment, the flowcell chamber 953 includes an inlet flowcell port 953a and outlet flowcell port 953b, which allow for controlled fluid transport through the fluid sample adapter 951 into the flowcell chamber 953 via the fluidic inlet 951a and fluidic outlet 951b. Typically, the flowcell inlet 953a is disposed below the flowcell outlet 953b when the fluid sample adapter 201 is oriented vertically to facilitate controlled fluid flow through the flowcell chamber 953. It should be understood that use of the terms “inlet” and “outlet” do not limit function of any fluid inlets or outlets described herein. Fluid can be introduced and evacuated from both or either. It is appreciated that the chip carrier device can be formed as an integral component or assembled from multiple components, and can incorporate various other features (e.g. valve, filter).

In some embodiments, the chip carrier device (or at least a partial assembly) is provided pre-attached to a sample cartridge with the fluid-tight couplings coupled with corresponding fluid ports of the cartridge. For example, a sample cartridge may be provided already coupled with the fluid sample adapter 201 such that an end-user can insert any chip within the chip carrier device 200 against the flowcell chamber to facilitate sample detection with a chip.

The flowcell portion of the chip carrier device is configured with an open chamber that, when interfaced with an active area of a chip within the chip carrier, forms an enclosed flowcell chamber to facilitate analysis of the fluid sample with the chip. The flowcell is shaped and configured to fluidly couple with a chip within a chip carrier attached to the fluid sample adapter 201. Typically, the fluidic pathway of the fluid flow portion fluidically connects to the flowcell chamber through fluid ports located at the top and bottom of the flowcell chamber. The chamber is formed by raised lands or ridges that come in contact with the active silicon or glass element used in the detection scheme. The active element is located on the chip carried within the chip carrier and secured to the flowcell by bonding and sealing, which can be accompished by various means (e.g. using epoxy preforms, dispensed epoxy or other adhesives, a gasket, a gasket with adhesive, mechanical features, or various other means). The purpose of the flowcell adapter is to create a complete flowcell chamber, bounded by the detection surface on one side and the flowcell adpater on the remaining sides. The flowcell can include one or more coupling features defined as alignment and assembly bosses as well as mechanical snaps that are received in corresponding holes to faciliate alignment of the chip when secured within.

The chip carrier device can include a contoured region dimensioned to receive the chip within. The contoured region includes a raised ridge along the perimeter thereof to engage a corresponding portion of the flowcell portion and effectively seal the chip within the chip carrier device. The raised lands or ridge around the open flowcell chamber engage an active surface of the chip so as to form an enclosed flowcell chamber. The chip carrier can include a window to provide access to the plurality of probe contacts defined on the chip itself or on an electrical interface of the chip device. Alternatively, the chip carrier device can be dimensioned so that the electrical interface of the chip or chip device extend beyond the distal end of the chip carrier device so as to be accessible by the instrument interface of the module.

It is appreciated that the chip carrier device with integrated fluid control can include any of the feature or structures described herein, or any of those described in U.S. Provisional Application No. 62/734,079 filed Sep. 20, 2018.

### II. Diagnostic Chip Devices and Assemblies

In one aspect, integrated diagnostic chip designs are described that further simplifies the fundamental design of the chip device, thereby reducing manufacturing costs and allowing for further integration and simplification of the chip device.

Embodiments previously described in U.S. Provisional Application No. 62/734,079 assume use of a chip design fabricated according to conventional techniques. The current low cost state of the art is to use chip on board (COB) strategies to eliminate separate semiconductor packaging elements. Generally, COB techniques rely on a PCB substrate to which the chip is mounted and perform wire bonding operations and subsequent bond protection operations on the device. The PCB serves the purpose of creating a mounting surface for the chip and utilizes vias on the PCB to electrically connect the chip to connection points (e.g. probe contact pads) disposed on the side opposite the chip. This approach allows a large number of contact pads to be distributed over the relatively large surface area on the opposite side of the chip. Use of a separate PCB in this manner aids the semiconductor processing workflow and is the widely accepted, most common approach. One significant drawback with this approach is that it is fairly expensive, requiring additional materials within the PCB (often costing as much as the chip itself) and incurs further expenses within the workflow steps needed to clean and mount the chip on the PCB. Therefore, the invention described herein provides alternative, integrated approaches to designing and fabricating a diagnostic chip to facilitate use within a chip carrier device and take advantage of existing sample preparation techniques while further reducing the fabrication and workflow costs of the chip. These approaches are advantageous over conventional COB techniques and allow for the further simplification without any modification or only slight modification in chip design.

There are several different approaches proposed for streamlining diagnostic chip design for use with the sample processing systems and methods described herein. These approaches include: (i) utilizing probe contacts on a separate PCB adjacent the chip, which allows for additional alternative approaches including: (ii) given the reduced size/thickness requirements of any PCB or support substrate of the diagnostic chip, replacing the PCB with a less expensive support substrate (e.g. thinner, lighter, more flexible, etc.) (iii) utilizing flex PCB and tab bonding techniques; (iv) using a metal core board to support the chip as a thermally conductive mount; (v) eliminating the substrate entirely and forming probe contact pads in the chip itself.

### A. Probe Contacts on Separate PCB

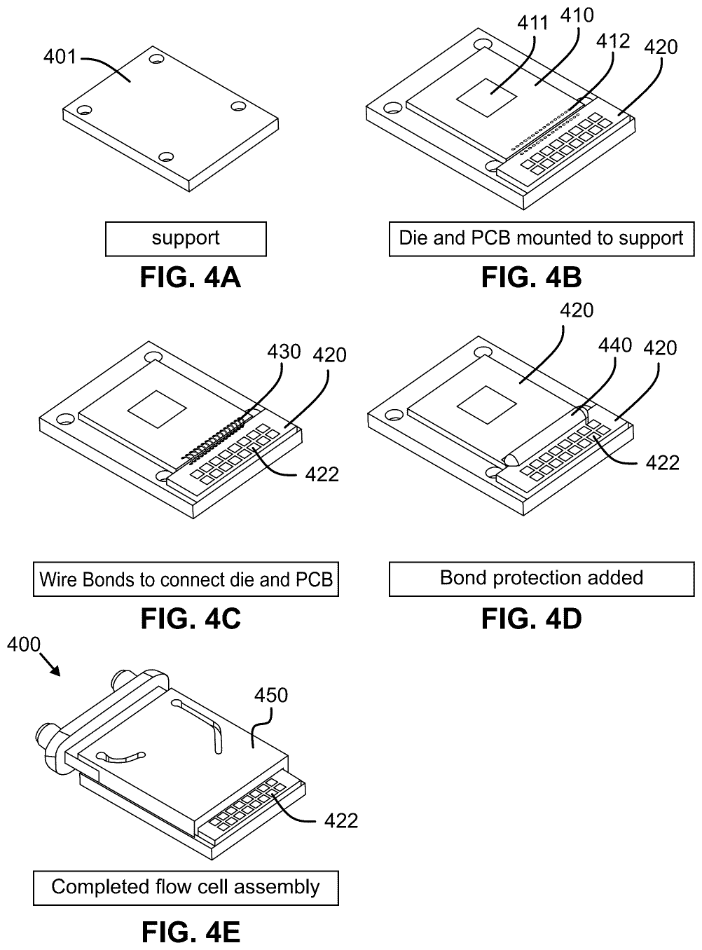

In a first aspect, the streamlined chip design entails substantially reducing the size of the PCB and moving the PCB alongside of the chip device (e.g. semiconductor/MEMs) and performing the wire bonding/wire bonding protection in the areas of co-adjacency of the components. In this approach, the diagnostic chip is designed to electrically connect with probe contacts provided on a separate PCB board. This allows the PCB board or substrate of the chip to be reduced in size and further allows the probe contacts to be probed from the same side as the chip. In some embodiments, this approach mounts both the PCB and device onto a separate surface, typically during the same pick and place operation of the semiconductor packaging work flow. This allows the mounting substrate to be very inexpensive, such as plastics and composites, and also opens the possibility of using thermally conductive metals or ceramics as the supporting substrate. This strategy generally prefers that the connections to the completed device be made from the same side as the devices. In some embodiments, this concept could be used and configured such that the probe contacts still face in the opposite direction. The main cost reduction is the size of the PCBs and the flexibility given to the process by allowing different PCBs and chip devices to be matched without significant redesigns. FIGS. 4A-4E illustrates sequential steps of assembling a chip device assembly 400 utilizing a chip having associated probe contact pads provided on a separate PCB, as described above.

FIG. 4A shows a support substrate 401, which can be smaller and thinner than would be customarily used if the probe contacts on a backside of the PCB by via connections. FIG. 4B illustrates a diagnostic chip 410 that is die cut and mounted on the substrate 400 with an active area 411 facing upwards and having an array of electrical contacts 412. In some existing chip designs, this array of contacts is considerably smaller than probe contact pads and are used for testing purposes during chip manufacturing. Adjacent the chip 410 is a PCB 420, having an area smaller than the chip area and having probe contact pads disposed on the same side as the chip. FIG. 4C shows the electrical contact array connected to the probe contacts 422 of PCB 420 by wire bonds 430. FIG. 4D shows the addition of bond protection 440 (e.g. layer of epoxy). FIG. 4E shows the assembly secured within chip device 450 having an integrated flowcell engaged with active area 411 (not visible). As can be seen, the probe contact pads 422 remain accessible to be probed by an electrical interface within a sample processing module in which the device 450 is inserted, as described in previous embodiments.

### B. Alternative Chip Substrates/Connection Types

Given that the probe contact pads are provided on a separate PCB, the support substrate of the chip can not only be smaller and thinner, but can utilize various different materials that are less expensive and/or have additional mechanical properties that provide further advantages. For example, the substrate can be a flexible material, such as a flex laminate, which are more economical. Further, the reduced area allows the substrate to be more easily mounted, for example, a self-adhesive flex laminate feature can be used as adhesive provides sufficient bond strength for a smaller lighter flex laminate (as compared to a conventional PCB component).

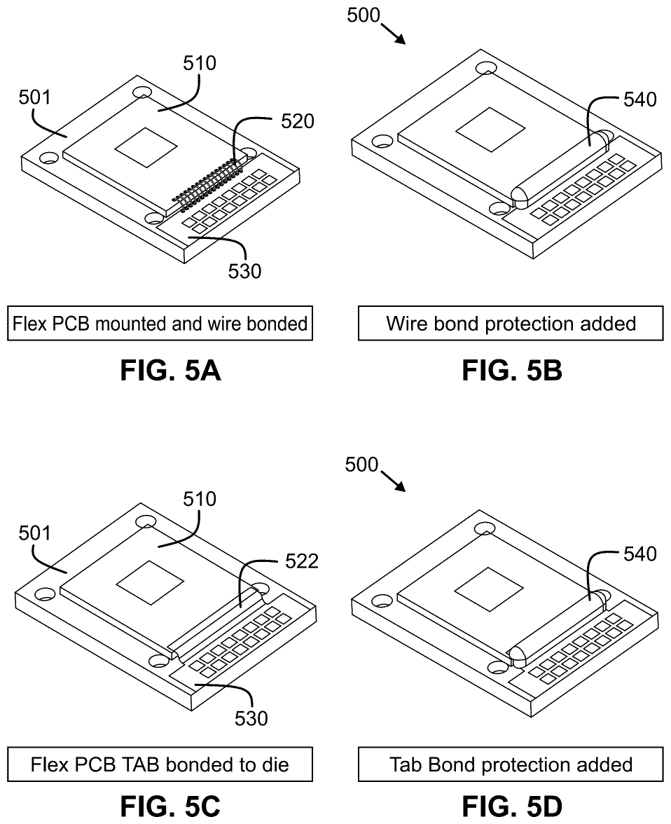

FIGS. 5A-5B shows assembly of another chip device assembly 500. In this example, the assembly includes a streamlined chip 510 with a mechanical chip support 501, which may be part of a flowcell, and flex PCB 530 mounted to a substrate 500. The probe contacts are electrically connected to the chip 510 by wire bonds 520 over which bond protection 540 is added.

In another aspect, the PCB on which probe contacts are provided can also be flex PCB. This lends itself to less expensive bonding methods such as TAB bonding techniques, which are generally cheaper and faster than wire bonding at very high volume production.

FIGS. 5C-5D show such an example chip device assembly 500 that includes a streamlined chip 510 and flex PCB 530 mounted to a substrate 500, with the probe contacts electrically connected to the chip 510 contacts by TAB bonding 522 over which bond protection 540 is added.

### C. On-Chip Probe Electrical Contacts/Connections

In yet another aspect, an integrated, streamlined chip can be designed that uses probe contact pads defined in the chip itself. This approach utilizes an additional portion of the chip (on a same side as the active area) such that wire bonded connections through a PCB are avoided. This design avoids the necessity of a separate PCB component for the probe contacts and further avoids any bonding procedures and various workflow steps. In some embodiments, the chip can be manufactured on an alternative support substrate, such as any of those described herein. Advantageously, the chip can be manufactured without any separate support substrate, for example, the silicon wafer in which the chip is defined can act as the support. In such embodiments, a step of thinning the silicon wafer is unnecessary, thereby providing a more cost effective and streamlined fabrication as compared to conventionally packaged chip devices. In such embodiments, any available wafers can be used, for example wafers having a thickness of 925, 775, 725, 675, 625, or 525 μm (thicknesses typically corresponding to wafer diameter). It is appreciated however that any suitable thickness wafer could be used.

This approach allows for an even more cost effective approach of eliminating the separate PCB entirely and thus any electrical bonding requirements to the chip. By putting the onus of making the electrical connections to the chip onto the instrument entirely, the need for a separate PCB, PCB Flex component, and wire or TAB bonds and protection can be completely eliminated. This allows for a design where the chip (e.g. bare silicon/MEMS device) can be mounted directly into an integral flowcell/chip carrier device. The elimination of the steps pertaining to the separate PCB and associated electrical connections save time and cost on the order of the cost of the chip itself. Typically, this approach prefers that the chip (e.g. silicon/MEMS device) has a reasonably low number of connections such that a sufficient area on the device can be allotted to the connections. This approach may incur some additional cost in regard to the additional area of silicon utilized for the contact connections, but for most chip designs, this increase in cost is significantly offset by the savings in the elimination of the separate PCB and associated reduction in workflow.

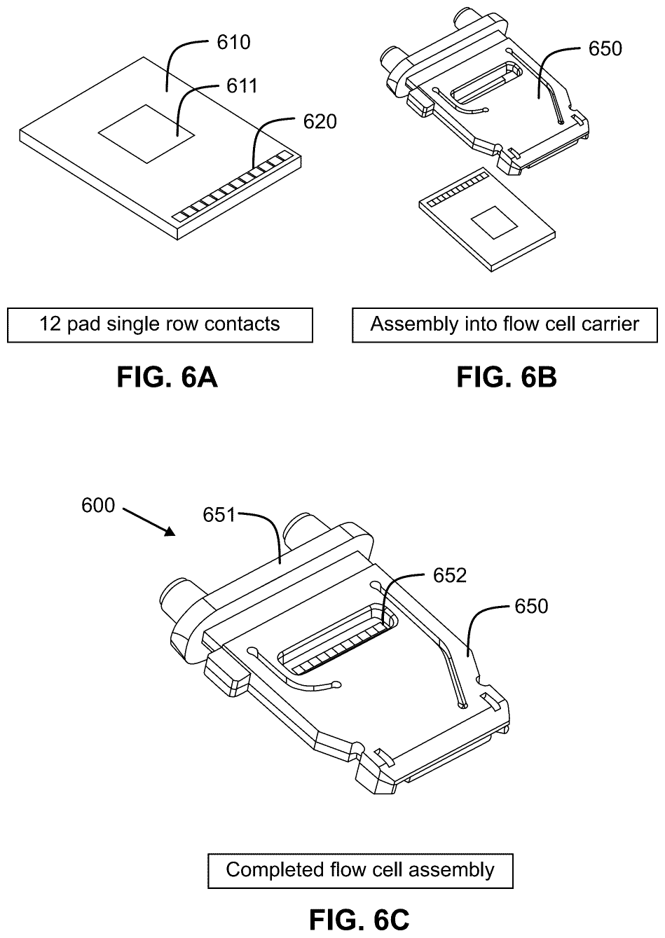

FIGS. 6A-6C show the assembly of an example chip device assembly 600 in accordance with the above approach. FIG. 6A shows the streamlined chip 610 having an active area 611 and a probe contact array 620 formed along one side of the same side. In this embodiment, chip 610 includes 12 pad single row contacts, although it is appreciated that fewer or more contact pads could be included. FIG. 6B shows assembly of the chip 610 within a chip carrier device 650 having an integrated flowcell. FIG. 6C shows chip 610 securely engaged within the chip carrier device 650 such that the active area is sealingly engaged with the integrated flowcell (not shown). As can be seen in FIG. 6C, the chip device 650 includes a flange 651 that can make a physical connection to the cartridge 100 and window 652 through which the contact pad array 620 can be accessed by probes of an electrical interface of a module in which the chip device 650 is inserted. In this embodiment, the contact pads are fairly small (e.g. 12 pads at 0.8 mm pitch). Such a design would require rather precise and small instrument connection interface design to ensure the probes consistently and reliably engaged the corresponding contact pads.

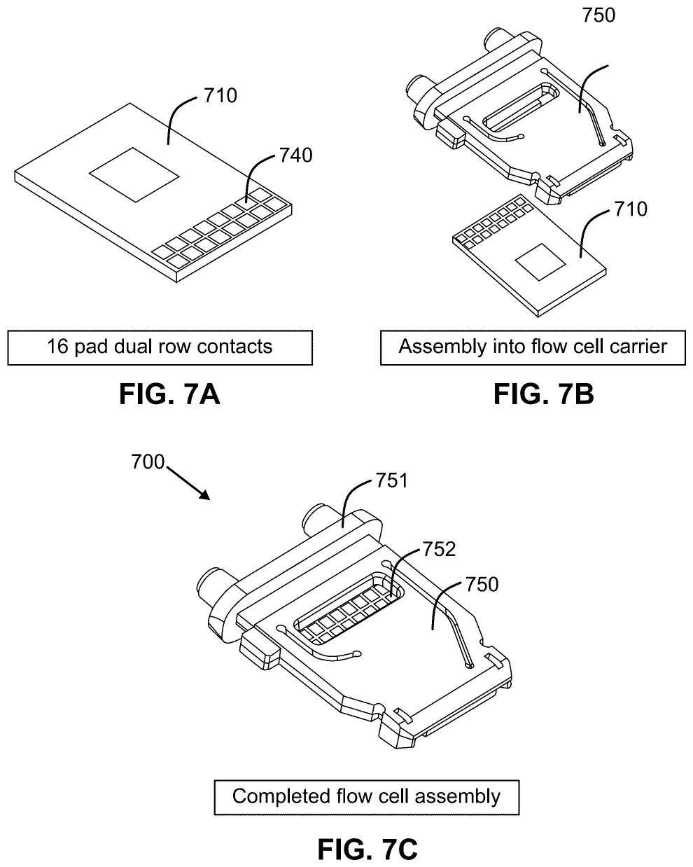

FIGS. 7A-7C show a substantially similar chip assembly 700, however, the chip 710 includes an integral probe contact array 740 defined in a dual row pad arrangement that sacrifices some additional area of the chip device to allow for sufficiently large number of pads, with each pad having sufficient area to make the instrument design significantly easier. In this embodiment, the spacing between the pads and arrangement of the pads allow use of a commonly available electrical contact arrangement (e.g. a 1.27 mm pitch, dual row, 16 pin pogo header). It is appreciated that the probe contact pads could be designed according to any dimension desired taking into account the available chip area. As in the previous embodiment, the chip 710 is secured within a chip carrier device 750 having a fluidic interface 751 and a window 752 through which the probe contact array 740 is accessible.

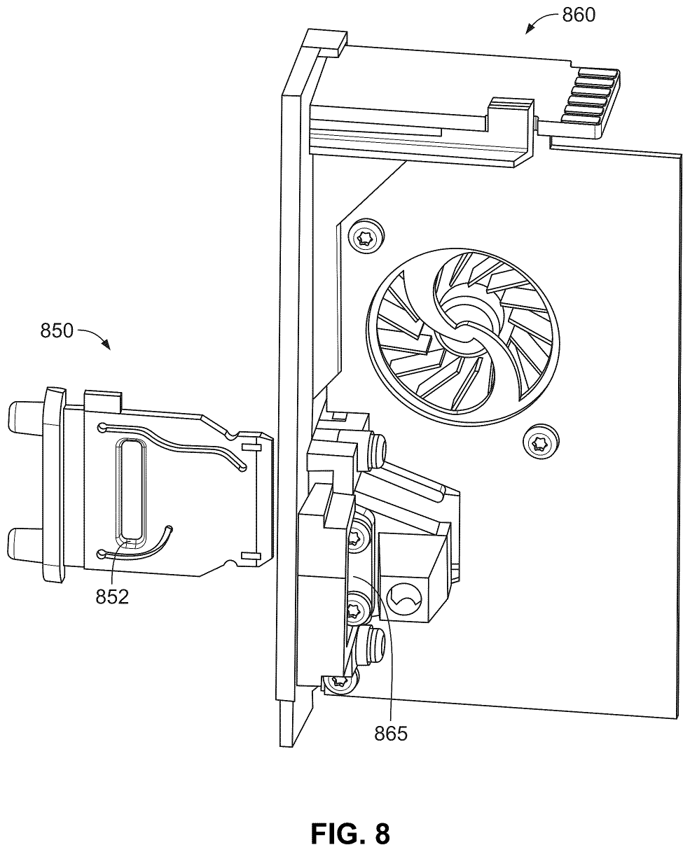

FIG. 8A shows a chip carrier device 850, in accordance with those described in FIGS. 6A-7C, before insertion into an instrument interface 860 of the module that includes a header 865 with probes (not visible) that engage corresponding on-chip contact pads exposed through window 852. The use and operation of the instrument interface with the chip is generally in accordance with the concepts discussed in the embodiments in FIGS. 1-3 and 8.

FIG. 9A-9C show detail views of a chip device assembly 900, in accordance with those described in FIGS. 6A-6C. FIG. 9A shows the chip carrier device 950 having an integrated flowcell chamber 953 in fluid communication with fluidic interface 951. The flowcell chamber is disposed within a recessed portion dimensioned to fittingly receive the chip 910 within so as to sealingly engage an active area of the chip against the flowcell chamber. The device can include a separate gasket to facilitate sealing or the gasket can be a raised portion defined within the device itself. In some embodiments, the chip carrier device 950 is formed as a unitary component and can be formed by injection molding or any suitable means. In other embodiments, the chip carrier device can be assembled by multiple components, for example, as in the previously described embodiments. The flowcell is filled with prepared fluid sample through flowcell inlet/outlet ports 953a, 953b in fluid communication with the inlet/outlet ports 951a, 951b of the fluidic interface 951.

As can be seen in the top view of FIG. 9B, the size and dimensions of the chip 951 corresponds to the recess in the chip carrier device 950. The chip carrier device 950 can include various retention or coupling features to secure chip 951 within, for example, retention tab 955 and snap-fit couplings 954 that are dimensioned and arranged to resiliently receive the chip and secure the chip with the active area sealingly engaged against the flowcell chamber. As can be seen in the underside view of FIG. 9C, the integrated flowcell/chip carrier device 950 includes a flowcell inlet channel 930a in fluid communication with fluidic inlet 951a of fluidic interface 951 and a flowcell outlet channel 930b in fluid communication with 951b such that the sample cartridge and module to which the device is attached precisely controls the flow of fluid sample from the fluid sample cartridge into the flowcell chamber through the fluidic interface. The chip 910 includes an integrated probe contact pad array 920 on the chip surface on a same side as the active area 911, the array being positioned to be accessible through the probe contact window 952 of the integrated flowcell/chip carrier device 950.

### III. Thermal Control Devices and Methods

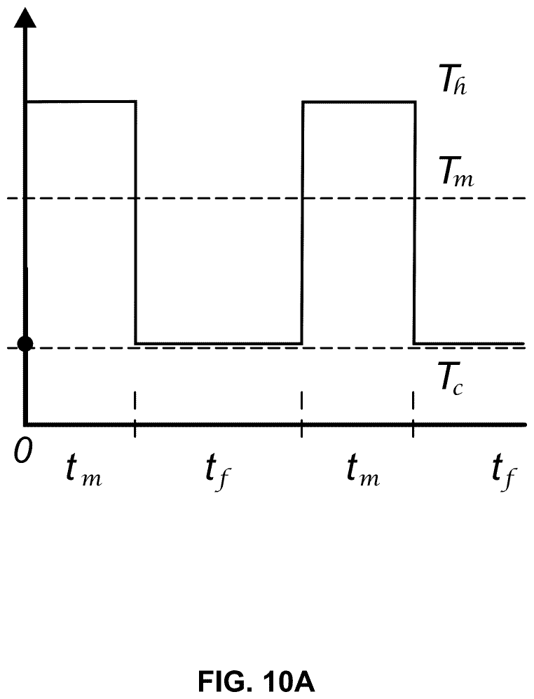

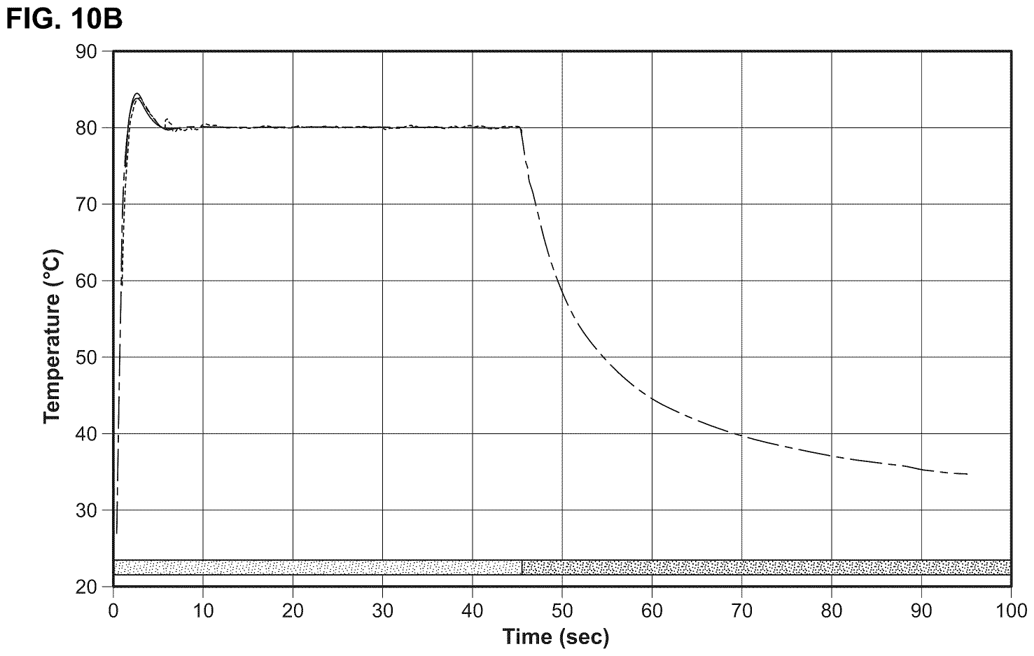

FIG. 10A shows an idealized control scheme for thermal cycling between elevated and reduced temperature as controlled by a square wave. Ideally, to prepare a biological sample for PCR testing, the biological sample is thermally cycled between an elevated temperature Tₕ and a reduced temperature T_{c}. FIG. 10A illustrates the melt temperature with Tₘ. FIG. 10A depicts time periods of higher temperature with tₘ and time periods of lower temperature with t_{f}. In many conventional systems, a heater or thermoelectric cooler (TEC) is placed near or in contact with a reaction tube or vessel containing the biological sample is controlled according to a square wave between a high temperature Tₕ and a lower temperature T_{c}, often the high temperature being greater than the target elevated temperature of the sample to improve speed of heating of the sample. While this approach provides suitable thermal cycling, the overall rate of thermal cycling is limited by cooling rates, and as a result thermal cycling is less efficient and more time consuming. FIG. 10B shows a thermal profile in a semiconductor diagnostic chip using conventional thermal cycling, which demonstrates a gradual cooling rate of the biological sample from the elevated temperature to the reduced temperature. This gradual cooling greatly increases the overall time of thermal cycling, as each thermal cycle must wait for the sample to obtain the reduced temperature after a gradual cooling. While various cooling approaches have been proposed, none as of yet, have provided a robust solution that is compatible with existing sample preparation systems. To overcome these challenges, the present disclosure provides a thermal component that includes a thermal switch that is specifically configured to engage the chip and aid in rapid cooling. Preferably, the thermal switch is incorporated into the instrument interface so as to be compatible with conventional sample preparation cartridges and chip carrier devices carrying semiconductor diagnostic chips.

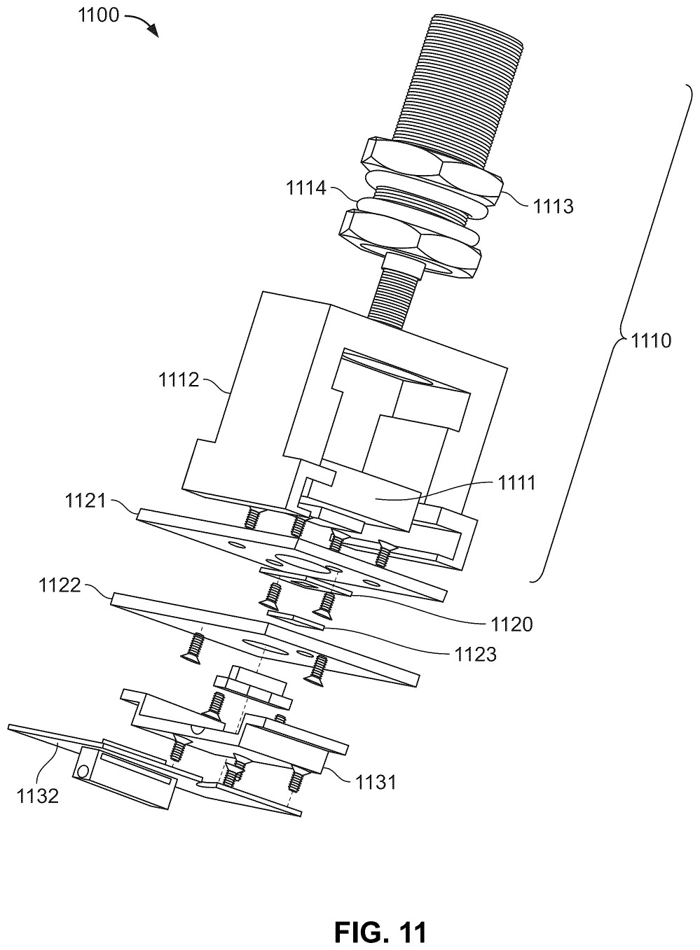

FIG. 11 shows a chip carrier and interface assembly 1100 that includes a thermal switch 1110, in accordance with some embodiments. This embodiment, the thermal switch 1110 includes a heat sink 1111 defined by a copper slug, which is supported in an air cylinder cradle 1112 attached to an air cylinder 1113, operation of which actuates movement of the heat sink 1111 within the cradle 1112 to engage the diagnostic chip 1120 during cooling. Optionally, the cradle 1112 can be attached to the air cylinder 1113 with levelling O-rings 1114. The air cylinder cradle 1112 is disposed adjacent the diagnostic chip cradle 1121, which supports the semiconductor diagnostic chip 1120 therein, the heat sink 1111 extending through a window in the chip cradle 1121 to engage the backside of the chip 1120. The other side of the chip 1120 having the active face is engaged with an O-ring 1123 and O-ring backer plate 1122. The instrument interface can further include an electrical interface with a pogo-pin connector having pogo pins on a pogo PCB 1132 supported by pogo cradle 1131 such that the pogo pins engage corresponding contacts on the active side of the chip 1120 when the chip carrier is inserted into the module.

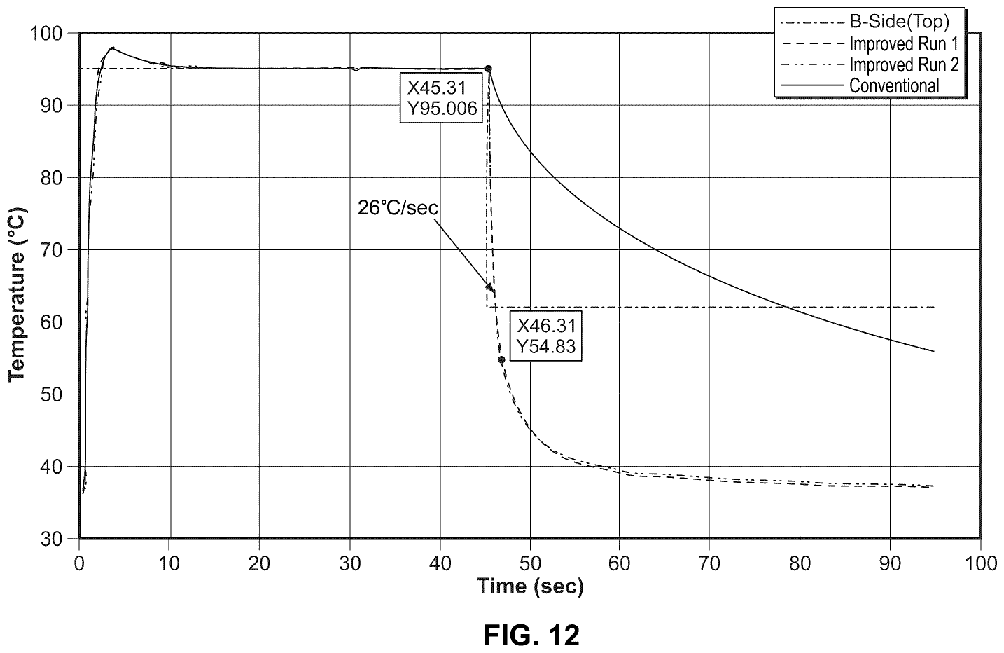

FIG. 12 shows a comparison of the gradual conventional thermal profile of the semiconductor diagnostic chip (solid line) and the improved thermal profile provided by the thermal switch (dashed line). As can be seen, the improved thermal profile has a relatively sharp drop, demonstrating a greatly improved cooling rate by use of the thermal switch of FIG. 11. In this approach, the cooling rate with the thermal switch has increased to 26° C./sec.

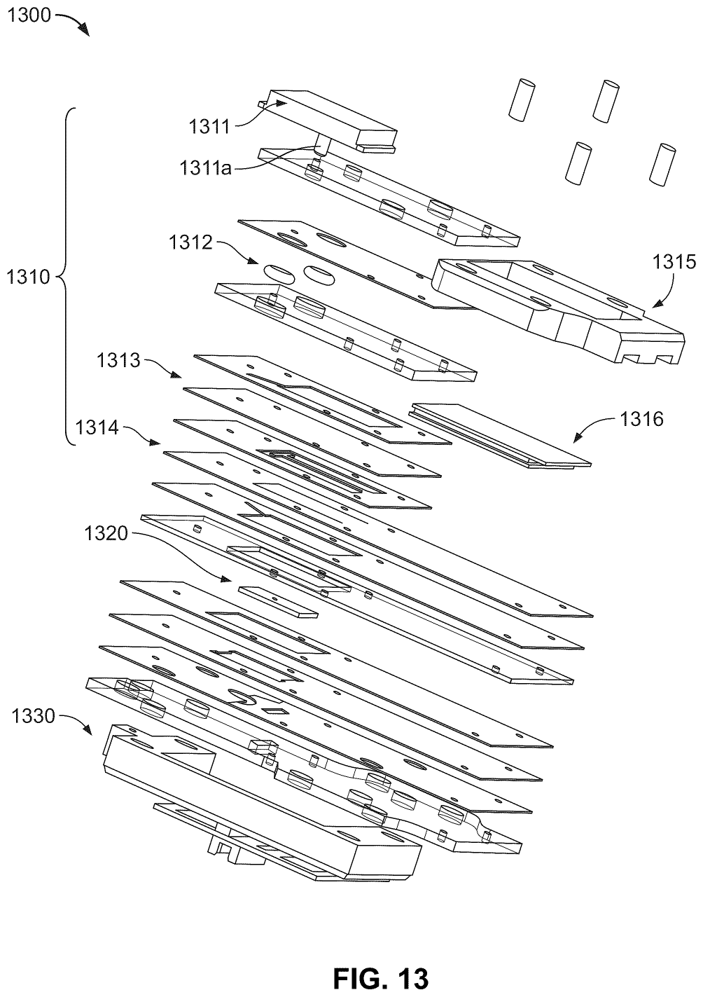

FIG. 13 shows another embodiment of an assembly 1300 that includes a thermal switch 1310. This thermal switch design uses an inflatable bladder that distends a thermally conductive sheet against the chip to increase the cooling rate. In this embodiment, the thermally conductive sheet is a pyrolytic highly oriented graphite sheet (PGS), although it is appreciated that any suitable material could be used (e.g. copper foil, etc.). In this embodiment, the thermal switch is incorporated into the chip carrier device that supports the diagnostic chip and is operated by an air pump that can be included within the chip carrier or can be part of the instrument interface. As shown, this embodiment includes a chip carrier with various interfacing layers that support the diagnostic chip 1320. The thermal switch includes an air pump 1311 with an air port 1311a that extends through a top layer or plate of the chip carrier, sealed by one or more O-rings 1312, such that the air flows into latex bladder 1313 to inflate the bladder to engage one side of the chip with the PGS film 1314 to facilitate cooling upon contact with the chip. The assembly can further employ a thermoelectric cooler (TEC) 1316 supported within a TEC cradle 1315 adjacent the thermal switch to facilitate heating and or steeper cooling rates of the chip. The assembly can further include an electrical interface that includes pogo pin assembly 1330 having pogo pins that interface with contacts on the opposite side of the chip 1320 to operate the chip 1320. In this embodiment, the TEC is operated to actively heat the chip 1320, thereby heating the biological sample disposed in a flowcell on an opposite side of the chip 1320, to the target elevated temperature, after which the bladder 1313 is inflated to rapidly cool the chip 1320 to the reduced temperature. This process is repeated as needed to perform thermal cycling of the sample per the required protocol.

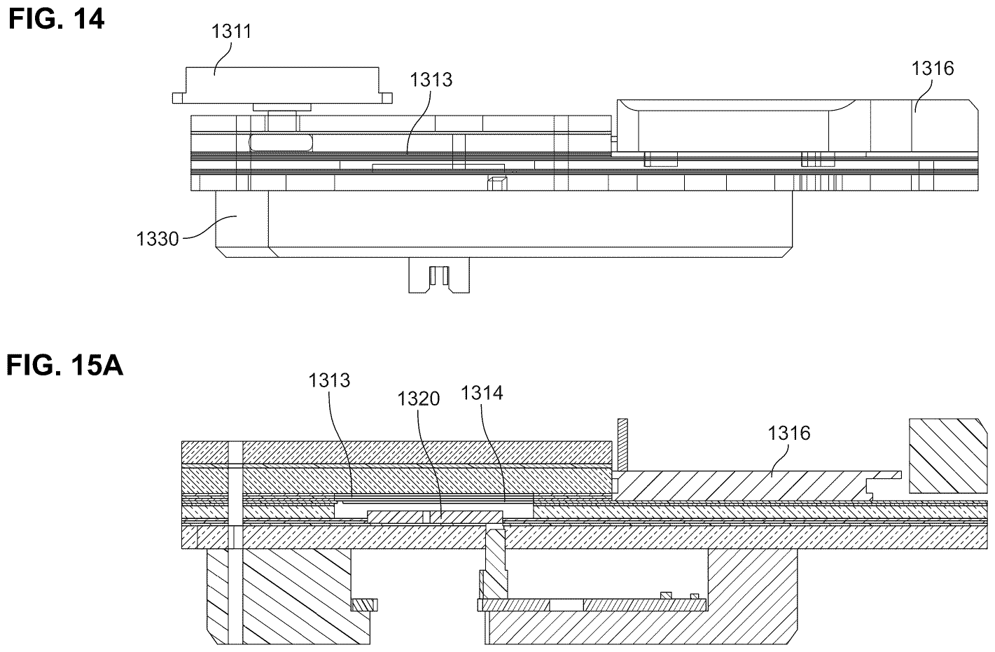

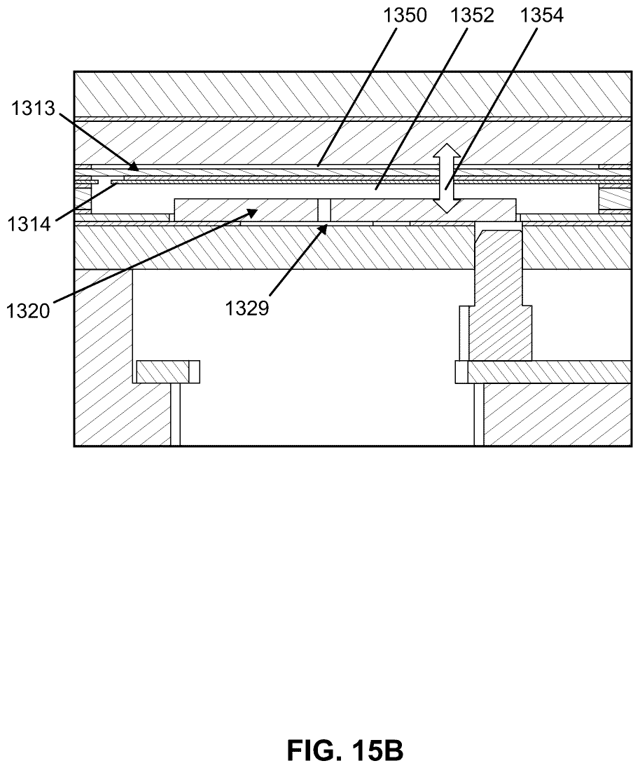

FIGS. 14 and 15A shows a side view and a cross-sectional view, respectively, of the thermal control assembly 1300 using an inflatable bladder thermal switch, in accordance with some embodiments. As shown in FIG. 14, the pogo pin assembly 1330 is disposed on one side so as to interface with one side of the chip to facilitate electrical operation of the chip. The opposite side of the chip is disposed against various layers that engage with TEC 1316 in TEC cradle 1315, and the inflatable bladder 1313 that is filled and deflated by operation of air pump 1311. Although specific air pumps are shown and described here, it is appreciated that any suitable air pumps could be used. FIG. 15A shows a cross-sectional view demonstrating the space between the PGS film 1314 and the chip 1320 before inflation of the bladder 1313. FIG. 15B shows an additional detail view of the assembly shown in FIG. 15A, which shows the sample chamber 1329 below the active face of the chip that contains the biological sample. As shown in the embodiment depicted in FIG. 15B, there is a first compression chamber 1350 for when the inflatable bladder thermal switch is on and a second compression chamber 1352 for when inflatable bladder thermal switch is off. In the embodiment depicted in FIG. 15B, chip 1320 may move as illustrated with the arrow 1354.

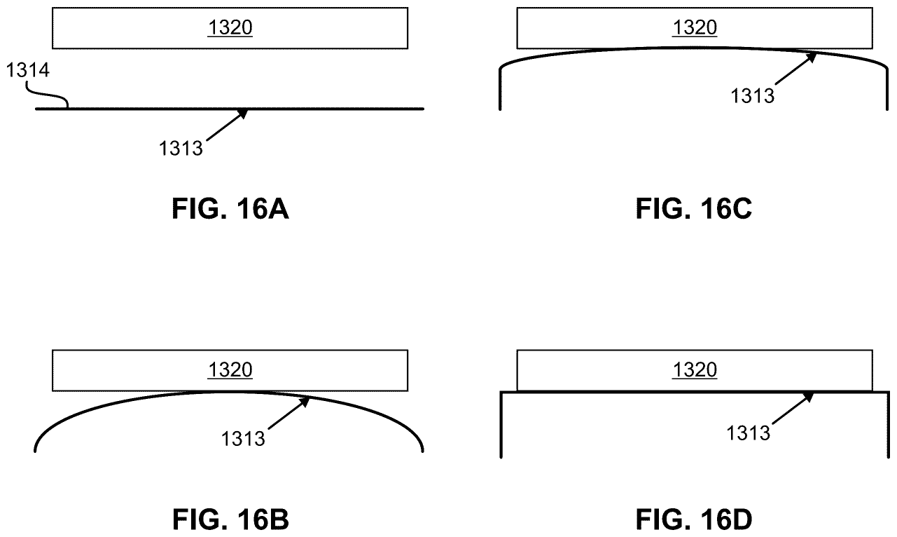

FIGS. 16A-16D show side views of variable thermal resistance provided by variable inflation bladder thermal switch, in accordance with some embodiments. By applying differing pressures to vary the level of inflation, the degree of contact of the thermal material disposed on the bladder can be varied to ensue proportional heating and or cooling. The different pressures allow proportional bladder deflection thereby providing a proportional contact area between the chip and bladder propelled flexible conductive material. This allows for throttling of cooling rates and even heating rates and help mitigate thermal overshoot. In addition once full contact area is achieved, continued thermal proportionality may continue by varying the force that the full contact area exerts on the chip in this regime, thereby varying the thermal contact resistance. Examples of differing contact areas provided by differing pressures are shown in the detail views of FIGS. 16A-16D, which show the proximity of the chip relative the bladder and thermal material layer within the assembly, such as that in FIG. 15A.

FIG. 16A shows the bladder 1313 without any inflation pressure in which there is no bladder 1313/thermal material 1314 contact with the chip 1320, thereby providing the highest level of thermal resistance. FIG. 16B shows low pressure applied to the bladder, which results in a small amount of contact (e.g. less than 30% of exposed chip surface) between the bladder/thermal material and the chip 1320, which provides a medium level of thermal resistance. FIG. 16C show a medium pressure applied to the bladder, which results in a moderate amount of bladder/thermal material contact (e.g. 40-60%) with the chip 1320, which provides low thermal resistance. FIG. 16D shows a high pressure applied to the bladder, which results in full bladder/thermal material contact with the chip across substantially the entire exposed chip surface, which provides the lowest thermal resistance. At full contact, a further but less pronounced reduction in thermal resistance can be achieved by further increases in bladder pressure which would in this regime start to change the thermal contact resistance due to higher forces between the chip and bladder.

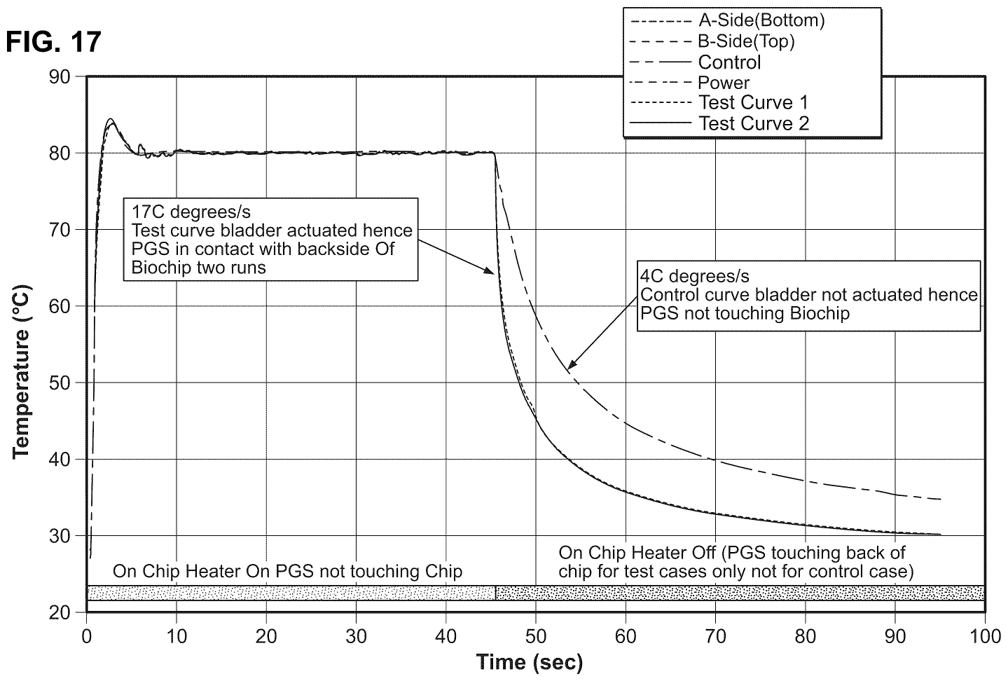

FIG. 17 shows a thermal profile of the semiconductor diagnostic chip utilizing a thermal switch having an inflatable bladder, in accordance with some embodiments. The thermal profile shows a control curve (at right) (long dashed) without the bladder 1313 activated, which demonstrates the gradual cooling. In contrast, the test curve (at left) (solid and short dashed) with the bladder 1313 activated to contact the PGS sheet 1314 to the backside of the chip 1320 results in a steep drop and marked increase in cooling rate.

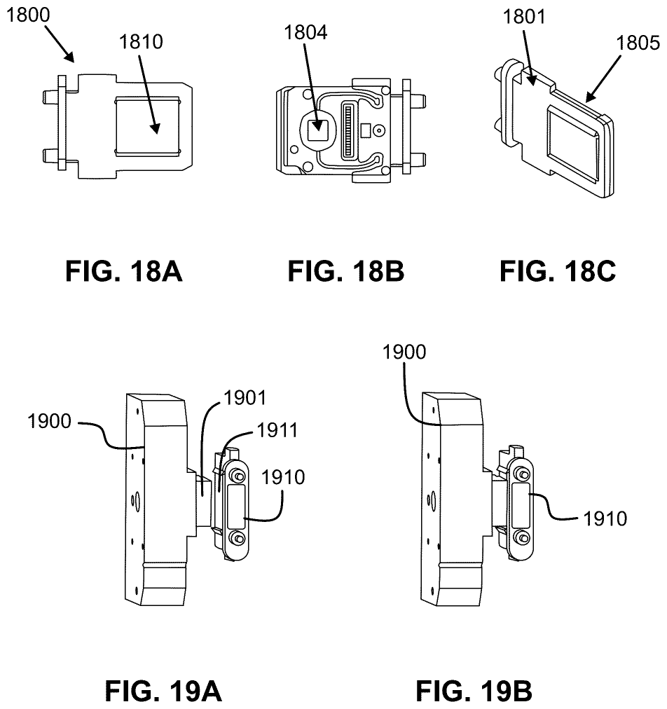

FIGS. 18A-18C show various views of an example chip carrier device 1800, in accordance with some embodiments. FIG. 18A is a front view. FIG. 18B is a back view. FIG. 18C is an isometric view. These figures depict a chip carrier device that includes a polymer frame 1810 that supports a diagnostic chip 1810 and is compatible with a sample cartridge and analytical module, such as that shown in FIG. 1. As shown, the chip carrier 1800 supports a semiconductor diagnostic chip 1810 within such that one side of the chip carrier defines a window for accessing the electrical contacts of the chip with the pogo connector and a liquid chamber 1804 that defines a flowcell for the biological sample to engage the active area of the chip (see FIG. 18B). In some embodiments, the carrier can also include optical lid 1805 disposed over the liquid chamber 1804. As can be seen in FIGS. 18A and 18C, the chip carrier frame 1801 is configured such that the backside of the chip (opposite the active face) is left exposed. This configuration allows for use of a thermal switch to improve cooling by thermal conduction with the back side.

In one aspect, the thermal switch is heat sink that moves to contact the back of the semiconductor diagnostic chip to improve cooling by thermal conduction. An example of such a heat sink is shown in FIGS. 19A-19B, which shows a heat sink 1900 with a protrusion 1901 spaced away from the diagnostic chip 1911 in a chip carrier frame 1910 during heating and which is moved to contact the diagnostic chip 1911 during cooling, respectively. FIG. 19A shows the heat sink 1900 during heating. FIG. 19B shows the heat sink 1900 during cooling. In this embodiment, a thermally conductive material (heat sink) 1900 contacts the chip 1911 enclosing the liquid chamber, which contains the sample, momentarily to remove the heat from the sample and the surrounding plastic (e.g. optical lid and the frame 1910) during thermal cycling. In some embodiments, the semiconductor has a series of resistive heaters that heats the sample to various set points as defined by the protocol. When the sample must be cooled, the heater is turned off and the chip 1911 is contacted by the heat sink 1900 momentarily to conduct heat away.

Since the heat sink contacts only the semiconductor side of the consumable and not the optical lid, the temperature of the liquid closer to the semiconductor is lower than the liquid closer to the optical lid. This results in temperature bounce back as heat flow from the optical side to the semiconductor side (i.e. higher to lower). In addition to the temperature difference in the liquid layer mentioned above, the liquid chamber is surrounded by various materials with different thermal conductivity. The plastic tends to conduct heat slower than the liquid. As a result, once the heat sink contact is removed from the semiconductor the heat from the surrounding plastic flows back into the liquid resulting in increasing in the liquid temperature. The phenomenon of increase in liquid temperature due to the temperature difference in the liquid and the surrounding plastic is called “thermal overshoot” also known as “thermal rebound”. In some embodiments, the thermal component includes additional features to address this overshoot, as discussed below.

FIGS. 19A-19B shows heat sink 1900 spaced away from the diagnostic chip 1911 during heating and moved to contact the diagnostic chip 1911 during cooling, respectively. As shown, the heat sink 1900 includes a protruding portion 1901 with a planar portion sized and shaped to contact an exposed portion 1911 of the semiconductor diagnostic chip 1911. The heat sink can be mounted on a moveable support that is moved by a servo motor, a modified servo motor that acts as a DC motor, a voice coil actuator, or any suitable means. In some embodiments, heat sink materials include aluminum (e.g., cooling of ˜110° C./s), black anodized aluminum (e.g. cooling of ˜40° C./s) or a combination thereof. In some embodiments, the thermal switch is configured to contact the semiconductor chip with a suitable force (e.g. 0.1N or greater, about 6N force) to ensure sufficient contact to facilitate thermal conduction for improved cooling. In some embodiments, to prevent thermal overshoot (thermal rebound), the heat sink is spaced away but remains in close proximities to the semiconductor chip (e.g. within 10 mm or less, within 5 mm or less, ˜3 mm away). In some embodiments, during cooling the heat sink contacts the semiconductor (i.e. 0 mm away).

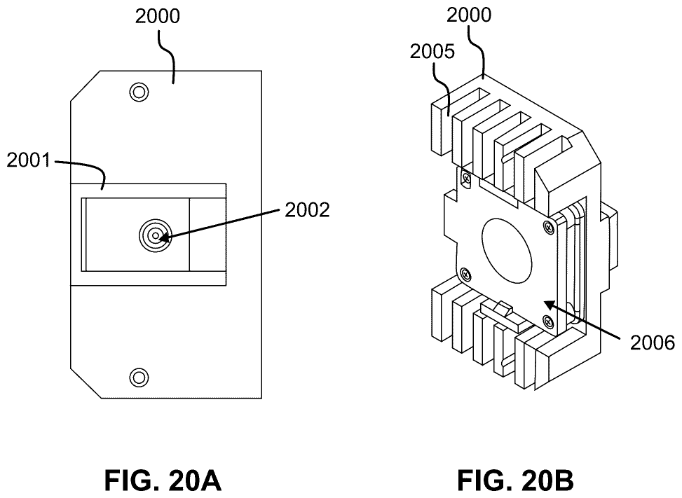

It is appreciated that various features or combinations of features may be used to address thermal overshoot. In some embodiments, the thermal overshoot feature can include one or more fans that blow onto the semiconductor chip immediately after cooling to suppress thermal overshoot. An example of this approach is shown in FIGS. 20A-20B, in which the heat sink 2000 includes an air outlet 2002 in the protruding portion 2001 that contacts the semiconductor chip (not shown). After contacting and cooling the chip to the reduced target temperature, the heat sink is spaced apart from the chip and the fan is operated to suppress thermal overshoot. As shown in FIG. 20B, the heat sink can include a fan 2006 on the rear side adjacent the cooling fins 2005, the air outlet being in the opposite side facing the chip.

In other embodiments, the thermal overshoot feature can include the heat sink itself being positioned in close proximities, yet spaced apart from the semiconductor chip. By maintaining the heat sink in close proximities (e.g. less than 3 mm, less than 2 mm, less than 1 mm, between 0 and 0.5 mm), studies have determined that the heat sink can pick up heat while in contact and when in near proximity to the semiconductor. The cooling capability of the heat sink reduces as it moves away from the semiconductor. This near proximity zone(s) is used to remove the overshoot. In this case, the heat sink picks up heat by convective and radiative heat transfer. In some embodiments, the heat sink is designed to run PCR tests back-to-back without any active cooling mechanism (i.e., external fan to cool the heat sink from the heat picked from the semiconductor while cooling) to cool off the heat sink (i.e., the heat sink does not gain enough heat to reduce the cooling rate or fail engineering requirement specifications).

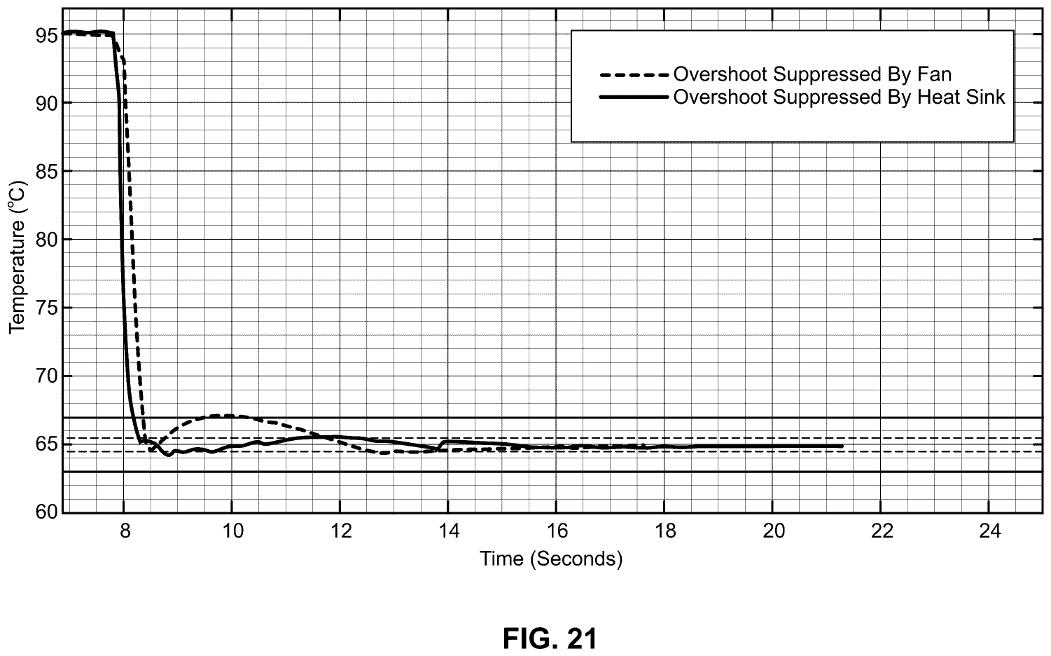

FIG. 21 shows thermal profiles of cooling of the semiconductor chip utilizing the two features noted above to inhibit thermal overshoot. As shown, the cooling fan approach (dashed) reduces the thermal overshoot, yet the increase in temperature is still appreciable and this approach required modification of the heat sink and the additional fan component. The second approach of maintaining the heat sink in close proximity provides a marked improvement in further reducing the incidence of thermal overshoot. Additionally, the second approach relies on the heat sink itself, without requiring additional modification or components.

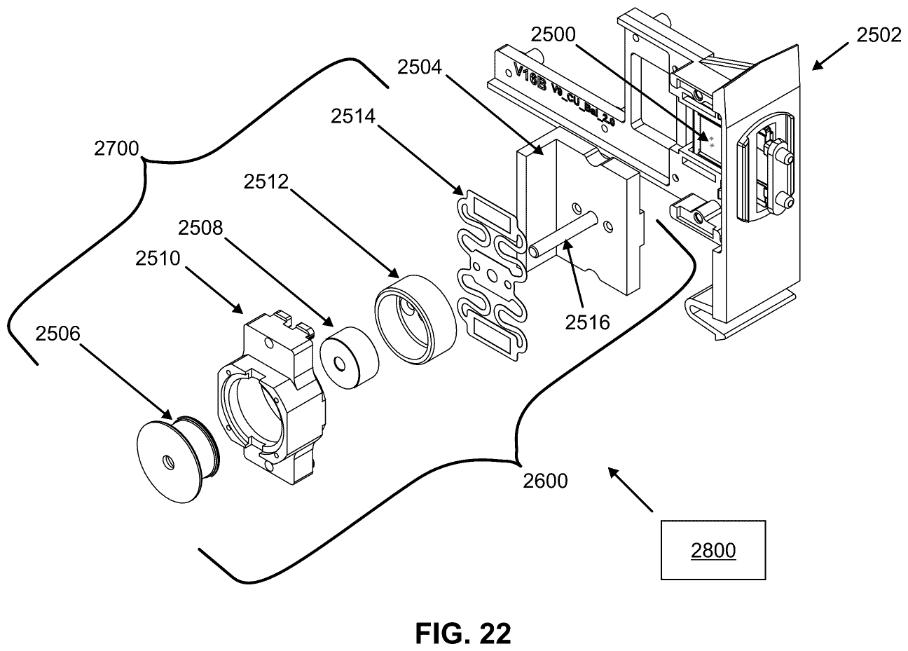

FIG. 22 shows a chip 2500 within a carrier and interface assembly 2502 that includes a thermal control component with a thermal switch 2600, in accordance with some embodiments. In embodiments, the thermal switch 2600 may perform a thermal control operation on a chip 2500, such as a cooling operation. According to this embodiment, the thermal switch 2600 may include a heat sink 2504 which may be moveable in accordance with a voice coil actuator 2700. In some embodiments the heat sink 2504 may be movable within a maximum distance of 5 mm from the chip 2500. In other embodiments the heat sink 2504 may be movable within a range of about 0 mm to 1 mm from the chip 2500, or within a range of about 0 mm to 2 mm from the chip 2500, or within another distance range of the chip 2500 suitable with the configuration of the instrument and other components. In the depicted embodiment, the voice coil actuator 2700 includes a coil of wire, such as copper wire, wrapped around a cylindrical former, such as a bobbin, (coil) 2506, within the magnetic field of a magnet 2508 that may be positioned within a case 2510 and an iron case 2512 such that the magnetic field is selectively contained. As shown in the embodiment in FIG. 22, the voice coil actuator may also include a spring 2514 and guide pin 2516 so that when current is applied it will push the magnet 2508 away from the coil 2506 and will move the heat sink 2504 toward the chip 2500 during cooling and when the current is no longer applied the spring 2514 will move the heat sink 2504 away from the chip 2500. The thermal switch 2600 may be controlled by a controller or control unit, such as a processor 2800 or other control component. In embodiments, under the control of a processor 2800 a motor driver may send out a signal to the voice coil actuator 2700 to cause movement. Preferably, the thermal switch 2600 may be compatible with conventional sample preparation cartridges and chip carrier devices carrying semiconductor diagnostic chips. While FIG. 22 depicts an embodiment that uses a voice coil actuator 2700 as a drive mechanism, other drive mechanisms such as a servo motor or DC motor may be used with a heat sink 2504. Using a voice coil is simple, advantageous to reduce power consumption, and provides proportional heating or cooling based upon the position of the heat sink 2504 from the chip 2500.

In this embodiment, the heat sink 2504 may engage the chip 2500 during cooling or it may stop within close proximity of the chip 2500 and vibrate. In other embodiments, the heat sink 2504 may engage the chip 2500 during portions of the cooling process and it may stop and vibrate within close proximity of the chip 2500 during portions of the cooling process. Repeatedly engaging and disengaging the chip 2500 with the heat sink 2504 may cool the chip 2500 with a high degree of temperature accuracy. This is beneficial as PCR cycles require precise control over the temperature for better results. Vibrating a conductive material, such as a heat sink 2504, in close proximity of the chip 2500 may be beneficial as the cooling rate is inversely related to the distance between the surface of the chip 2500 and the surface of the conductive material. Additionally, vibrating the conductive material causes convective cooling that can counteract the heat that the convective material receives from cooling the chip 2500.

Using the principle of Lorentz force, the heat sink 2504 may be precisely moved. Cooling of the chip 2500 may occur within a certain threshold distance between the chip 2500 and the heat sink 2504. For example, the threshold distance for cooling may be within about 0.5 mm, 0.6 mm, 0.7 mm, 0.8 mm, 0.9 mm, or some other distance defined by the specific properties of the chip 2500, heat sink 2504, instrument, and other factors. As used herein, the threshold distance for cooling is defined as the “thermal boundary”. In one embodiment, the thermal boundary may be determined by positioning a heat sink 2504 at different distances from a chip 2500 and monitoring the power consumption by a heat source for the chip 2500 to maintain an elevated temperature. For example, the temperature of the chip 2500 could be held constant and the power consumption by a heat source of the chip could be monitored so that when the power consumption by the heat source needs to increase to maintain the temperature of the chip 2500 due to the proximity of the heat sink 2504 the thermal boundary has been located. In some embodiments, similar to the process for suppressing overshoot described above, the control unit determines the number of “proximity positions” to optimize cooling rate in relation to the threshold distance for cooling. The “proximity positions” have varying level of cooling rate, e.g., a position closer to the chip has a higher level of cooling capacity and it reduces as the thermal conductive material moves away from the chip 2500. The control unit uses these “proximity positions” to its advantage to cool the chip 2500, cool the heat sink 2504, and also to suppress thermal overshoot.

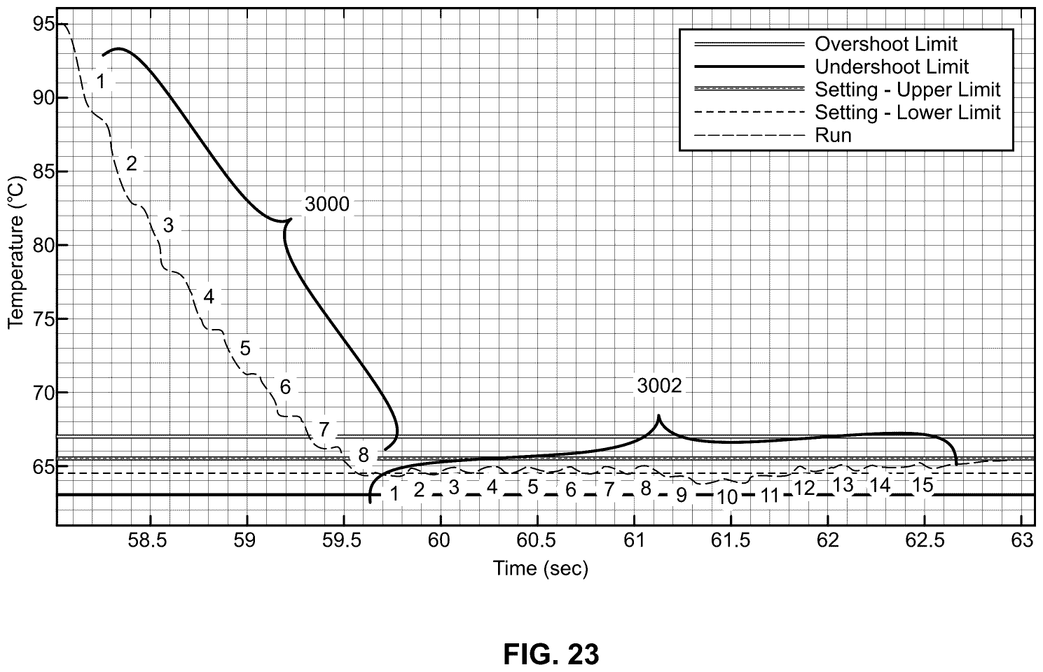

FIG. 23 shows a thermal profile of a semiconductor diagnostic chip utilizing a thermal switch according to the thermal switch 2600 embodiment depicted in FIG. 22, in accordance with some embodiments. The thermal profile shows one methodology of using the thermal switch 2600 in three different methods in conjunction, Zone A 3000, Zone B 3002, and Zone C 3004 (not shown). In Zone A 3000, the heat sink 2504 engages the chip 2500 for a short duration and then disengages the chip 2500 for a short duration. The engagement time and disengagement time may be varied, for example, the engagement time may be at least 50 ms and the disengagement time may be 75 ms. The engagement time may be equal to or different from the disengagement time. This serial engagement and disengagement (step) may be repeated a number of times, such as at least three times, at least five times, at least ten times, at least 50 times, or at least 100 times. According to the embodiment depicted in FIG. 23, Zone A 3000 may have eight engagement and disengagement steps. In that embodiment, the engagement step may be 100 ms and the disengagement step may be 100 ms. In addition, to the Zone A 2000 engagement time, disengagement time, and number of times the chip 2500 is engaged and disengaged, the duty cycle may be variable. According to the embodiment depicted in FIG. 23, Zone A 3000 may have a duty cycle of 78.4%, such that the heatsink 2504 is within the thermal boundary of the chip 2500 for 78.4% of the total time duration of Zone A and outside of the thermal boundary of the chip 2500 for 21.6% of the total time duration of Zone A. In embodiments, the duty cycle functions in accordance with the principle of Pulse Width Modulation (PWM). In other embodiments, the duty cycle may be between 0-100%. The system may be linear such that controller may control the amount of power that is applied to the voice coil actuator 2700 thereby determining the position of the heat sink 2504 from the chip 2500. The chip 2500 engagement time, the chip 2500 disengagement time, the number of times the chip 2500 is engaged and disengaged by the heat sink 2504, and the duty cycle may be variables that may be adjusted, such as based upon test and environmental conditions.

In embodiments, the entire cooling process may consist of steps of the heat sink 2504 engaging and disengaging the chip 2500. In other embodiment, the cooling process may also consist of steps of maintaining the heat sink 2504 in close proximity to the surface of the chip 2500. For example, according to the embodiment depicted in FIG. 23, after the steps of Zone A 3000 are completed, the cooling process continues into Zone B 3002 and Zone C 3004. In the depicted embodiment, Zone B 3002 and Zone C 3004 may be similar to Zone A 3000 but in Zone A 3000 the heat sink 2504 engages the chip 2500 while in Zone B 3002 and Zone C 3004 the heat sink 2504 is maintained in close proximity of the surface of the chip 2500 during the engagement time period of Zone A. According to the embodiment depicted in FIG. 23, Zone B 3002 may have fifteen close proximity and outside of close proximity steps. In that embodiment, the Zone B 3002 close proximity step may be 100 ms and the outside of close proximity step may be 100 ms. According to the embodiment depicted in FIG. 23, Zone B 3002 may have a duty cycle of 52.9%. According to the embodiment depicted in FIG. 23, Zone C 3004 (not shown) may have fifteen close proximity and outside of close proximity steps. In that embodiment, the Zone C 3004 close proximity step may be 100 ms and the outside of close proximity step may be 100 ms. According to the embodiment depicted in FIG. 23, Zone C 3004 may have a duty cycle of 39.2%. In some embodiments, the thermal switch 2600 could be used with different methods. In other embodiments, the thermal switch 2600 could be used with any number Zones (as described herein), such as one Zone, two Zones, five Zones, etc.

As is illustrated by FIG. 23, the engagement of the heat sink 2504 with the chip 2500 directly results in a steeper drop in chip 2500 temperature and increase cooling rate when compared to maintaining the heat sink 2504 within close proximity of the chip 2500. The combination of Zone A 3000, Zone B 3002, and Zone C 3004, may use conductive cooling and convective cooling wherein during the convective cooling phases the vibrating of the heat sink 2504 cools both the chip 2500 and the heat sink 2504 itself. In some embodiments, the cooling process may consist of only steps of maintaining the heat sink 2504 in close proximity to the surface of the chip 2500. Using a methodology analogous to the one depicted in FIG. 23, may help cool a chip with more control and better accuracy, and have faster cooling rates in the range of 30-80° C./s.

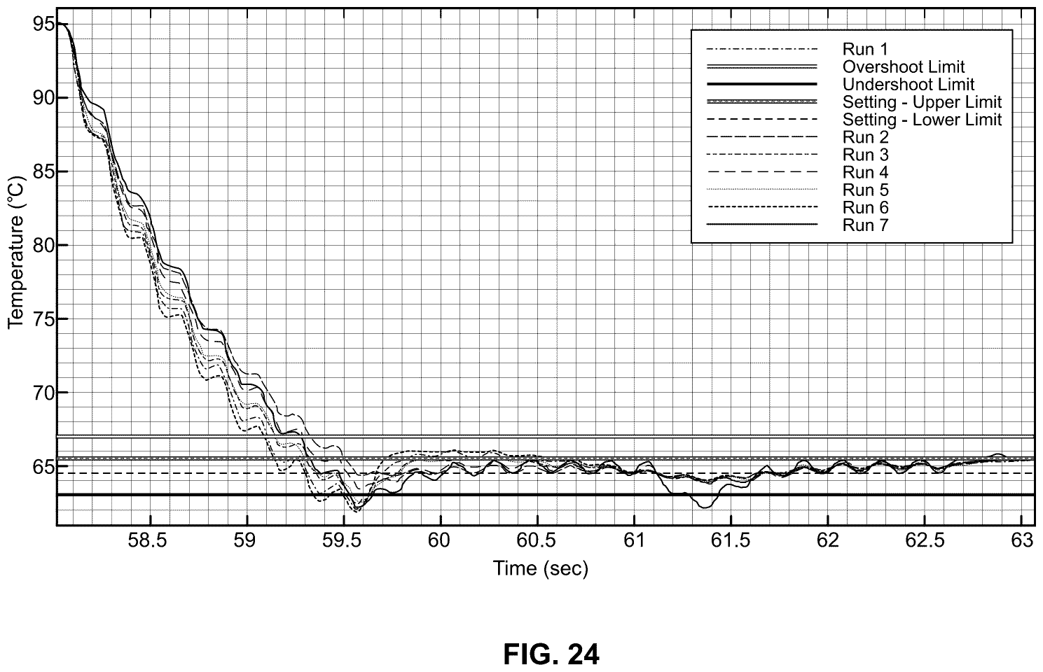

FIG. 24 shows the thermal profiles of semiconductor diagnostic chips utilizing a thermal switch according to the thermal switch 2600 embodiment depicted in FIG. 22 and the methodology described in reference to FIG. 23 in accordance with some embodiments. As illustrated by the multiple runs depicted in the graph in FIG. 23, the method described in reference to FIG. 23 demonstrates consistent results of precise control over the temperature. The above noted features are advantageous in improving thermal cycling for several reasons. First, the disclosed concepts described herein provide a faster time to result (TTR). Second, these concepts allow thermal cycling at wide range of temperature and moderately dusty environment allows the customer to use the instrument in such environments. This use case is increasing in developing countries where accessibility to hospitals or test centers is difficult and increasing mobile hospitals where paramedical team visits patient at their place. Thus, the methods herein provide faster cooling and ability to reach setpoint temperatures with minimal deviation. While the above features are described with respect to thermal cycling of a semiconductor diagnostic chip, it is appreciated these concepts could be applied to improve cooling during thermal cycling of any vessel or container of a biological fluid sample, particularly vessels formed of metal or any thermally conductive material.

In the foregoing specification, the invention is described with reference to specific embodiments thereof, but those skilled in the art will recognize that the invention is not limited thereto. Various features, embodiments and aspects of the above-described invention can be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

1. A thermal control unit comprising:
a slug of thermally conductive metal;
a cradle supporting the slug of thermally conductive material so as to be movable within the cradle, the cradle having a distal portion that is engaged adjacent a semiconductor diagnostic chip and/or a chip carrier device supporting the diagnostic chip; and
an air cylinder coupled to the cradle and having an air passage by which pressurized air is transmitted to move the slug in a distal direction so that the slug moves within the cradle and contacts a surface of the diagnostic chip to cool the diagnostic chip by thermal conduction.

2. The thermal control unit of claim 1, wherein the slug is a mass of a metal having a protruding portion that is shaped and dimensioned to contact the surface of the diagnostic chip.

3. (canceled)

4. (canceled)

5. The thermal control unit of claim 1, further comprising:
a control unit configured to selectively apply pressurized air via the air cylinder so as to selectively move and engage the diagnostic chip with the slug during one or more cooling portions of thermal cycling.

6. The thermal control unit of claim 1, further comprising:
a heater positioned adjacent the diagnostic chip and configured to selectively heat the diagnostic chip during heating portions of thermal cycling.

7. A thermal control unit comprising:
a chip carrier device having one or more layers for supporting a semiconductor chip therein;
a thermally conductive layer disposed adjacent the diagnostic chip and movable between a first position spaced apart from the diagnostic chip and second position in contact with the diagnostic chip; and
an inflatable bladder disposed adjacent the diagnostic chip with the thermally conductive layer disposed between the inflatable bladder and the diagnostic chip,
wherein the assembly is configured such that when the inflatable bladder is inflated, the thermally conductive material in the second position contacts a backside of the diagnostic chip and when the inflatable bladder is deflated the thermally conductive material is disposed in the first position spaced apart from the backside of the diagnostic chip.

8. The thermal control unit of claim 7, wherein the bladder is inflatable to one or more intermediate positions to allow for proportional contact area between the thermally conductive layer and chip to allow for proportional cooling and or heating.

9. The thermal control unit of claim 7, wherein when the bladder is inflatable to provide full area contact with the chip and pressure is further variable to change the thermal contact resistance between said the thermally conductive layer and chip thereby enabling a secondary mode of proportional cooling and or heating.

10. The thermal control unit of claim 7, further comprising: an air pump coupled with the inflatable bladder.

11. The thermal control unit of claim 7, wherein the air pump is disposed in an instrument of a module that interfaces with the chip carrier device and removably couples with the inflatable bladder through one or more conduits or openings through one or more layers of the chip carrier device.

12. The thermal control unit of claim 7, wherein the thermally conductive material comprises a PGS film.

13. The thermal control unit of claim 10, further comprising:
a control unit operatively coupled with the air pump and configured to selectively inflate the inflatable bladder to effect cooling during cooling portions of thermal cycling.

14. The thermal control unit of claim 10, wherein the control unit is further configured to deflate the inflatable bladder after cooling during the thermal cycling process to facilitate heating during heating portions of thermal cycling.

15. (canceled)

8. (canceled)

9. (canceled)

10. (canceled)

11. A thermal control unit comprising:
a heat sink comprising a mass of thermally conductive material, wherein the heat sink comprises a protruding portion that is sized and dimensioned to engage a surface of a diagnostic chip;
a moveable support that supports the heat sink and is configured to move the heat sink between multiple positions; and
a controller configured to move the moveable support between the multiple positions, including a first position spaced away from the diagnostic chip to facilitate heating and a second position where the protruding portion is in contact with the surface of the diagnostic chip to facilitate cooling.

20. (canceled)

21. (canceled)

22. (canceled)

23. The thermal control unit of claim 19, wherein the heat sink comprises:
one or more features to inhibit thermal overshoot.

12. The thermal control unit of claim 21, wherein the one or more thermal overshoot features comprise:
an air blower that directs air at the surface of the diagnostic chip after cooling to inhibit thermal overshoot after the heat sink is withdrawn from the surface of the diagnostic chip.

13. The thermal control unit of claim 22, wherein the air blower comprises a fan that directs air through an air outlet disposed in the protruding portion of the heat sink directly at the surface of the diagnostic chip.

26. The thermal control unit of claim 19, wherein the one or more thermal overshoot features comprise:
one or more close proximity positions of the heat sink held in close proximity to the surface of the diagnostic chip after cooling to suppress thermal overshoot.

27. The thermal control unit of claim 26, wherein the one or more close proximity positions comprise a plurality of close proximity positions having varying cooling rates.

28. The thermal control unit of claim 26, wherein the one or more close proximity positions comprises a proximity of 3 mm or less from the surface of the diagnostic chip.

29. The thermal control unit of claim 26, wherein the one or more close proximity positions comprises a distance between 0 and 0.5 mm from the surface of the diagnostic chip.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)
